(19) United States
(12) Patent Application Publication
(10) Pub. No.: US 2024/0079165 A1
(43) Pub. Date: Mar. 7, 2024

(54) SOFT MAGNETIC POWDER, MAGNETIC CORE, MAGNETIC COMPONENT, AND ELECTRONIC DEVICE

(71) Applicant: TDK CORPORATION, Tokyo (JP)

(72) Inventors: Yuta NAKAGAWA, Tokyo (JP); Kazuhiro YOSHIDOME, Tokyo (JP); Isao NAKAHATA, Tokyo (JP)

(73) Assignee: TDK CORPORATION, Tokyo (JP)

(21) Appl. No.: 18/457,839

(22) Filed: Aug. 29, 2023

(30) Foreign Application Priority Data
Aug. 31, 2022 (JP) 2022-138400

(51) Int. Cl. H01F 1/12; H01F 3/08

(52) U.S. Cl. CPC H01F 1/12; H01F 3/08

(57) ABSTRACT

A soft magnetic powder including a first particle group including particles having a particle size of D50 or more and a second particle group including particles having a particle size of less than D50. An average value of circularities of the particles belonging to the first particle group is defined as a first average circularity C1, and an average value of circularities of the particles belonging to the second particle group is defined as a second average circularity C2, and C1<C2 is satisfied.

### BACKGROUND OF THE INVENTION

### 1. Technical Field

The present invention relates to a soft magnetic powder, a magnetic core, a magnetic component, and an electronic device.

### 2. Description of the Related Art

A soft magnetic ribbon has a relatively uniform composition, and attempts have been made to use a pulverized powder obtained by pulverizing the soft magnetic ribbon for a magnetic component such as a magnetic core. For example, WO 2020/179535 A proposes performing a spheroidizing treatment on a pulverized powder obtained by pulverizing a soft magnetic ribbon.

In the related-art technique, measures have been made to reduce core loss, but when a soft magnetic ribbon is pulverized into a pulverized powder, stress is applied by crushing, so that coercivity is increased, and a permeability tends to be reduced.

### CITATION LIST

### Patent Literature

Patent Literature 1: WO 2020/179535

### SUMMARY OF THE INVENTION

The present invention has been made in view of such circumstances, and an object thereof is to provide a soft magnetic powder, a magnetic core, a magnetic component, and an electronic device capable of improving a permeability.

As a result of intensive studies on a soft magnetic powder capable of improving the permeability, the present inventors have paid attention to a particle size and a circularity, and newly found that the permeability can be improved when these are in a certain relationship, thereby completing the present invention.

That is, a soft magnetic powder according to the present invention includes:
a first particle group including particles having a particle size of D50 or more;
and a second particle group including particles having a particle size of less than D50, in which
an average value of circularities of the particles belonging to the first particle group is defined as a first average circularity C1,
an average value of circularities of the particles belonging to the second particle group is defined as a second average circularity C2, and
C1<C2 is satisfied.

The present inventors have found that a relative permeability is improved by satisfying C1<C2 even when the composition of the soft magnetic powder is the same.

Preferably, a gradient of an approximate straight line obtained from a circularity distribution with respect to the particle sizes of the particles belonging to the first particle group and the second particle group is −0.00154 μm or more and −0.00014 μm or less.

Preferably, the dispersion of the circularity distribution of the soft magnetic powder is 0.002 or more and 0.040 or less.

Preferably, an average value of circularities of particles belonging to a third particle group including particles having a particle size of D45 or more and less than D55 among the particles belonging to the first particle group and the second particle group is defined as a third average circularity C3, and
the third average circularity C3 is 0.6 or more and 0.92 or less.

Preferably, the particles belonging to the first particle group and the second particle group each have a main surface and a thickness perpendicular to the main surface.

Preferably, an average aspect ratio indicating a ratio of the particle thickness with respect to an equivalent circular diameter obtained from an area of the main surface is 1 or less.

The magnetic core of the present invention includes the soft magnetic powder described above.

The magnetic component of the present invention includes the soft magnetic powder described above.

The electronic device of the present invention includes the soft magnetic powder described above.

### BRIEF DESCRIPTION OF THE DRAWINGS

FIG. 1A is a perspective diagram showing an example of a particle of a soft magnetic powder according to an embodiment of the present invention;

FIG. 1B is a plan diagram of the particle shown in FIG. 1A;

FIG. 1C is a side diagram of the particle shown in FIG. 1B;

FIG. 1D is a schematic diagram showing observation results of particles having a high circularity by Mophorogi;

FIG. 1E is a schematic diagram showing observation results of particles having a low circularity by Mophorogi;

FIG. 2A is a graph showing a relationship between a particle size and a circularity of a soft magnetic powder according to an embodiment of the present invention;

FIG. 2B is a graph showing a relationship between a particle size and a circularity in a soft magnetic powder according to Comparative Example of the present invention;

FIG. 3 is a schematic diagram showing an example of a manufacturing device of a soft magnetic alloy ribbon;

FIG. 4 is a schematic diagram showing an example of a pulverizing method of a soft magnetic ribbon;

FIG. 4A is a schematic diagram of a pulverizing irregular surface of a roller shown in FIG. 4; and

FIG. 5 is a perspective diagram illustrating an example of a magnetic core manufactured by using a soft magnetic powder according to an embodiment of the present invention.

### DETAILED DESCRIPTION

Hereinafter, embodiments of the present invention will be described.

### First Embodiment

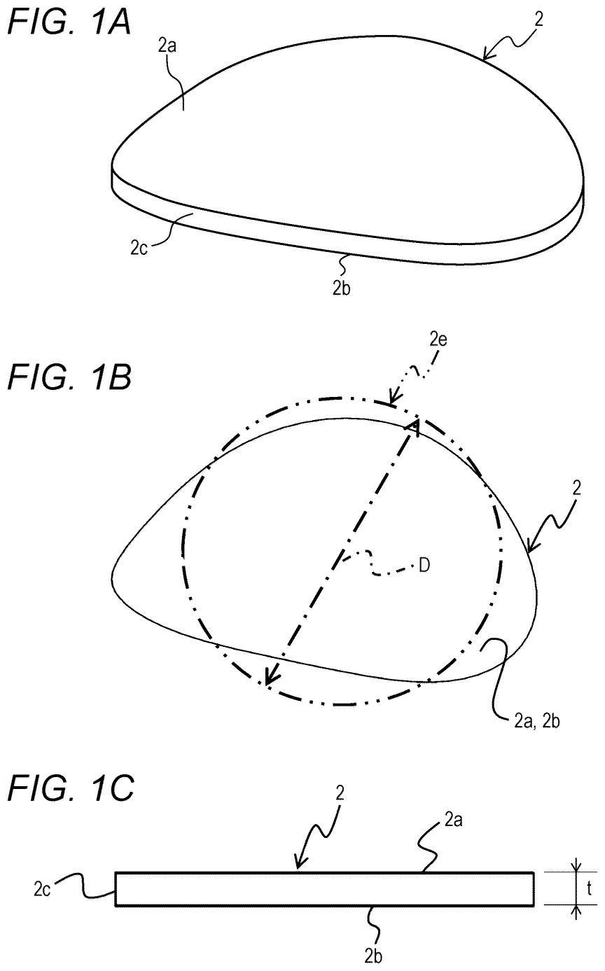

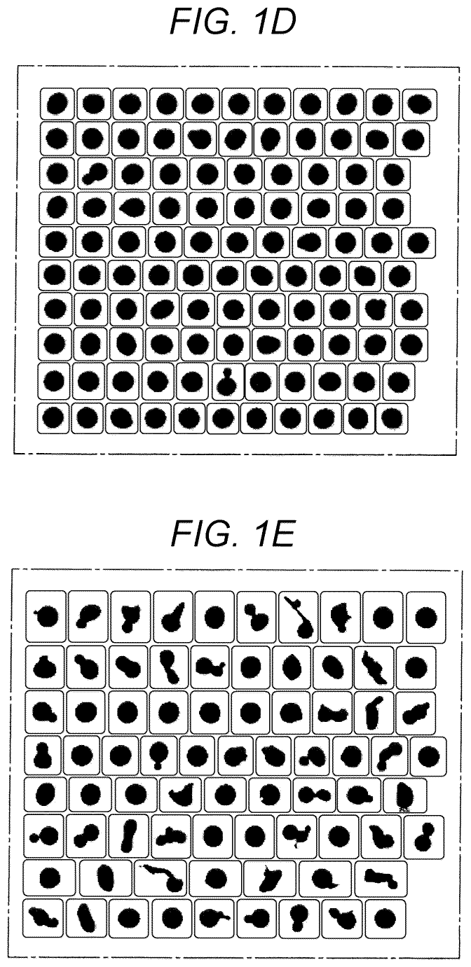

The soft magnetic powder according to the present embodiment is an aggregate of soft magnetic alloy particles obtained by pulverizing a soft magnetic alloy ribbon, and for example, as shown in FIG. 1A, each of soft magnetic alloy particles 2 has a flat plate shape and has two main surfaces 2a and 2b and a side surface 2c.

The two main surfaces 2a and 2b as a whole are substantially parallel to each other and have flat surfaces, but each of the main surfaces 2a and 2b may have irregularities on their surfaces, and each of the main surfaces 2a and 2b does not necessarily have to be a plane, and may have a convex or concave curved surface at least partially. That is, a surface in contact with a roll when the soft magnetic alloy ribbon is prepared or a surface opposite thereto serves as a main surface.

The side surface 2c is substantially perpendicular to the main surfaces 2a and 2b, but is not necessarily perpendicular to the main surfaces 2a and 2b, and may be inclined or have irregularities. In addition, the side surface 2c may have a convex or concave curved surface at least partially, and an intersection corner portion between the side surface 2c and each main surface 2a or 2b may have a rounded shape. That is, the side surface 2c of the soft magnetic alloy particle 2 is a fracture surface when a metal ribbon is pulverized.

It is preferable that the soft magnetic powder according to the present embodiment has a large number of soft magnetic alloy particles 2, and an average aspect ratio indicating a ratio of the particle thickness to the equivalent circular diameter obtained from the area of the main surface is 1 or less. It is more preferably 0.5 or less, and still more preferably 0.15 or less. The aspect ratio of the soft magnetic alloy particle 2 can be measured, for example, as follows.

First, as shown in FIG. 1B, the area of the flat main surface 2a or 2b of the soft magnetic alloy particle 2 is obtained by image processing or the like, and a diameter of a perfect circle 2e as a virtual circle corresponding to the area of the flat main surface 2a or 2b is obtained by automatic calculation to obtain a particle size D. The particle size D of the soft magnetic alloy particle 2 is preferably 38 to 355 μm. In addition, a distance between the main surfaces 2a and 2b of the soft magnetic alloy particle 2 is obtained by image processing or the like to obtain a thickness t. The thickness t of the soft magnetic alloy particle 2 is preferably 10 to 100 μm, and more preferably 10 to 30 μm. t/D is defined as the aspect ratio. In addition, the average aspect ratio can be obtained by randomly extracting at least 100 or more soft magnetic alloy particles 2 from the soft magnetic powder according to the present embodiment, and calculating and averaging the aspect ratios of the respective particle as described above. In a case of a shape of the core, planar polishing and image observation with a constant polishing thickness are alternately repeated, and the series of images obtained may be analyzed by using serial sectioning, in which a 3D image is constructed on a computer.

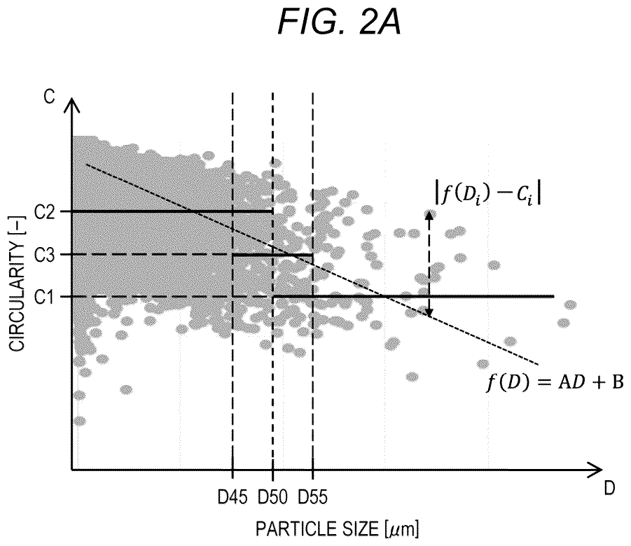

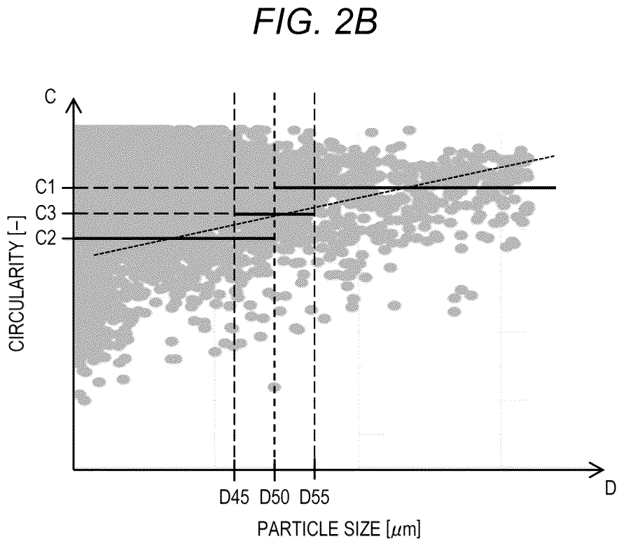

In the present embodiment, the soft magnetic powder is an aggregate of particles having various particle sizes, and as shown in FIG. 2A, the soft magnetic powder can be divided into a first particle group including particles 2 having a particle size of D50 or more and a second particle group including particles 2 having a particle size of less than D50. Here, D50 is preferably 38 μm or more and 355 μm or less. When an average value of the circularities of the particles 2 belonging to the first particle group is defined as a first average circularity C1 and an average value of the circularities of the particles belonging to the second particle group is defined as a second average circularity C2, C1<C2 is satisfied in the present embodiment. C1/C2 is preferably 0.80 or more and 0.98 or less, more preferably 0.91 or more and 0.98 or less, and still more preferably 0.91 or more and 0.96 or less.

The circularity of the particle 2 can be obtained as follows by using, for example, Mophorogi G3 (Malvern Paralytical). The Mophorogi G3 is a device capable of dispersing a powder by air, projecting individual particle shapes, and evaluating the shapes. Specifically, as can be seen from particle shape measurement results shown in FIGS. 1D and 1E, it is possible to project and evaluate a large number of particle shapes at a time.

In practice, a much larger number of particle shapes can be projected and evaluated at a time than described in the particle shape measurement results shown in FIGS. 1D and 1E. Note that FIG. 1D is a projection result of particles having a high circularity, and FIG. 1E is a projection result of particles having a low circularity. In the present embodiment, at the time of projection, in the Mophorogi G3, it is considered and evaluated that the main surface 2a or 2b is projected from the principle of dispersing the powder by air and observing the naturally dropped powder.

Since the Mophorogi G3 can prepare and evaluate a projection diagram of a large number of particles at a time, it is possible to evaluate the shapes of the large number of particles in a short time as compared with an evaluation method by the related-art scanning electron microscope (SEM) observation or the like. For example, a projection diagram is prepared for 20,000 or more particles, a circularity of each particle is automatically calculated, and an average circularity can be calculated on the number basis.

The circularity of the particle can be calculated as, for example, a Wadell roundness. The Wadell roundness is defined by a ratio (equivalent circular diameter/diameter of circumscribed circle) of a diameter (equivalent circular diameter) of a circle equal to a projected area of a particle cross section with respect to a diameter of a circle circumscribing the particle cross section in the projection diagram. A circularity of a perfect circle is 1, and the closer the circularity of the particle is to 1, it is to a circle.

Note that an average particle size, a particle size of D50, an average aspect ratio, an existence ratio of particles having a particle size of 160 μm or more, and the like can also be obtained by using the Mophorogi G3. Here, D50 is a particle size when an integrated value of the particle size of the particles included in the soft magnetic powder on the number basis is 50%.

As shown in FIG. 2A, in the soft magnetic powder of the present embodiment, for example, the circularity of each of 20,000 or more randomly extracted particles 2 is plotted with respect to the particle size (unit: micrometer), and straight line approximation is performed by a method of least squares, whereby a gradient A of distribution in a distribution approximate expression f(D)=A×D+B can be obtained. In the present embodiment, the gradient A is preferably −0.0015/μm or more, more preferably −0.0006/μm or more, and is preferably −0.0001/μm or less, and more preferably −0.0004/μm or less. Note that B is a constant indicating a value at which the approximate expression intersects a vertical axis.

In addition, a dispersion σ² (mean square error) of the distribution obtained from the graph of the circularity distribution as illustrated in FIG. 2A is preferably 0.002 or more and 0.040 or less, more preferably 0.005 or more and 0.040 or less, and still more preferably 0.005 or more and 0.015 or less.

Note that the dispersion σ² (mean square error) of the circularity distribution can be represented by, for example, the following mathematical formula.

$${σ}^{2} = \frac{1}{n} {\sum }_{i} {( f ( {d}_{i} ) - {c}_{i} )}^{2} \qquad [ Mathematical Formula 1 ]$$

In the mathematical formula, n is a total number of particles observed, Dᵢ is a particle size of an i-th observed particle, and Cᵢ is a circularity of the i-th observed particle.

In the present embodiment, for example, as shown in FIG. 2A, when an average value of circularities of particles belonging to a third particle group including particles having a particle size of D45 or more and less than D55 among the particles belonging to the first particle group and the second particle group is set as a third average circularity C3, the third average circularity C3 is preferably 0.60 or more and 0.92 or less, more preferably 0.60 or more and 0.85 or less, and still more preferably 0.75 or more and 0.85 or less.

Furthermore, in the present embodiment, particles having a particle size of 160 μm or more (preferably particles within a range of 160 to 1000 μm) among the particles belonging to the first particle group and the second particle group are included in an amount of preferably 30 mass % or more, and more preferably 60 mass % or more. An upper limit of the existence ratio of the particles having the particle size of 160 μm or more is determined from a viewpoint of a filling property and the like, and is preferably 90 mass % or less.

The thickness t of the soft magnetic alloy particle 2 can be obtained from the distance between the main surfaces 2a and 2b by image processing or the like, and is preferably 10 to 100 μm, and more preferably 10 to 30 μm.

In the present embodiment, a material and a composition of the particles 2 belonging to the first particle group and the second particle group are not particularly limited as long as they have soft magnetism, and examples thereof include hetero-amorphous Fe—Si—B based alloys, Fe—Co—Si—B based alloys, Fe—Si—B—Nb—Cu based alloys having nanocrystals, and Fe—B—Nb based alloys.

A microstructure of each particle 2 of the soft magnetic powder according to the present embodiment is also not particularly limited, but for example, the particles of the soft magnetic powder according to the present embodiment may have a structure including only amorphous, or may have a nano-heterostructure in which initial fine crystal exists in the amorphous material. The initial fine crystal may have a mean particle diameter of 0.3 to 10 nm. Alternatively, the particles of the soft magnetic powder according to the present embodiment may be particles composed of a nanocrystal phase, or may be particles in which an amorphous phase and a nanocrystal phase are mixed. In addition, among the nanocrystal structures, a Fe-based nanocrystal structure may be particularly used.

The nanocrystal refers to a crystal having a particle diameter on a nano order. The Fe-based nanocrystal is a crystal having a particle diameter on the nano order and of which a crystal structure mainly composed of Fe is bcc (body-centered cubic lattice structure). In the present embodiment, it is preferable to deposit the Fe-based nanocrystal having a mean particle diameter of 5 to 30 nm.

Hereinafter, a method for confirming whether the particle 2 (the same applies to the soft magnetic alloy ribbon) of the present embodiment has an amorphous structure (a structure including only amorphous material or a nano-heterostructure) or a crystal structure will be described. In the present embodiment, it is assumed that a soft magnetic alloy ribbon having an amorphization ratio X of 85% or more indicated by the following formula (1) has an amorphous structure, and a soft magnetic alloy ribbon having an amorphization ratio X of less than 85% has a crystal structure.

X=100−(Ic/(Ic+Ia)×100) (1)
Ic: crystalline scattering integrated intensity
Ia: amorphous scattering integrated intensity

The amorphization ratio X is calculated by performing crystal structure analysis on a soft magnetic alloy ribbon by an X-ray diffraction method (XRD), identifying a phase, reading a peak (Ic: crystalline scattering integrated intensity, Ia: amorphous scattering integrated intensity) of crystallized Fe or a compound, determining a crystallization rate from the peak intensity, and calculating by using the above formula (1). Hereinafter, the calculation method will be described more specifically.

The particle 2 according to the present embodiment is subjected to crystal structure analysis by XRD, and profile fitting is performed by using a Lorentz function to obtain a crystal component pattern indicating a crystalline scattering integrated intensity, an amorphous component pattern indicating an amorphous scattering integrated intensity, and a pattern obtained by combining these. From the crystalline scattering integrated intensity and the amorphous scattering integrated intensity of the obtained pattern, the amorphization ratio X is obtained by the above formula (1). The measurement range is a range of diffraction angle 2θ=30° to 60° at which a halo derived from amorphous material can be confirmed. Within this range, an error between the integrated intensity actually measured by XRD and the integrated intensity calculated by using the Lorentz function is set to be within 1%.

In addition, when an amorphous property is evaluated in a magnetic core, it can be confirmed by observation of a microstructure with a scanning transmission electron microscope (STEM). That is, it can be determined by analyzing an area ratio between an amorphous portion and a nanocrystal or crystal portion. That is, when the area ratio of the amorphous portion is 85% or more, it is defined as amorphous, and when an initial fine crystal of about 0.1 to 10 nm is observed in a high resolution image, it may be defined to have a nano-heterostructure.

The particles 2 constituting the soft magnetic powder of the present embodiment may be, for example, a soft magnetic alloy having a main component with a composition formula (Fe_{(1-(α+β))}X1_{α}X2_{β})_{(1-(a+b+c+d))}MₐB_{b}P_{c}Si_{d} (atomic ratio).
X1 is one or more selected from the group consisting of Co and Ni,
X2 is one or more selected from the group consisting of Al, Mn, Ag, Zn, Sn, As, Sb, Cu, Cr, Ga, Bi, N, O, C, and S, and a rare earth element, and
M is one or more selected from the group consisting of Nb, Hf, Zr, Ta, Mo, Ti, W, and V.

Preferably 0≤a≤0.150,
0≤b≤0.200,
0≤c≤0.200,
0≤d≤0.200,
0.100≤a+b+c+d≤0.300,
α≥0,
β≥0, and
0≤α+β≤0.50 may be satisfied.

The Fe amount (1−(a+b+c+d)) is not particularly limited, but may be 0.700≤(1−(a+b+c+d))≤0.900.

In the present embodiment, a part of Fe may be substituted with X1 and/or X2.

X1 is one or more selected from the group consisting of Co and Ni. The amount of X1 may be α=0. That is, X1 may not be contained. The number of atoms of X1 is preferably 40 at % or less when the number of atoms in the entire composition is 100 at %. That is, it is preferable to satisfy 0≤α{1−(a+b+c+d)}≤0.40.

The amount of X2 may be β=0. That is, X2 may not be contained. The number of atoms of X2 is preferably 3.0 at % or less when the number of atoms in the entire composition is 100 at %. That is, it is preferable to satisfy 0≤β{1−(a+b+c+d)}≤0.030.

The range of the substitution amount for substituting Fe with X1 and/or X2 may be half or less of Fe based on the number of atoms. That is, 0≤α+β≤0.50 may be set.

The soft magnetic powder of the present embodiment may include elements other than the above as inevitable impurities. For example, the soft magnetic powder may include the inevitable impurities in an amount of 0.3 mass % or less, and more preferably 0.1 mass % or less.

The composition having Fe-based nanocrystals by a heat treatment has been described above, but the microstructure of the soft magnetic alloy ribbon is not particularly limited.

(Manufacturing Method)

Hereinafter, a manufacturing method of the soft magnetic powder of the present embodiment will be described. First, a soft magnetic alloy ribbon is manufactured.

The manufacturing method of the soft magnetic alloy ribbon of the present embodiment is not particularly limited. For example, there is a method of manufacturing a soft magnetic alloy ribbon by a single-roller melt-spinning method. The ribbon may be a continuous ribbon.

In the single-roller melt-spinning method, first, a pure raw material of each element included in the finally obtained soft magnetic alloy ribbon is prepared, and weighed so as to have the same composition as that of the finally obtained soft magnetic alloy ribbon. Then, the pure raw materials of the respective elements are melted and mixed to prepare a base alloy. Although a method for melting the pure raw material is arbitrary, for example, there is a method in which the pure raw material is vacuumed in a chamber and then melted by high frequency heating. The base alloy and the soft magnetic alloy ribbon finally obtained usually have the same composition.

Next, the prepared base alloy is heated and melted to obtain a molten metal (molten metal). The temperature of the molten metal is not particularly limited, but may be, for example, 1100 to 1600° C.

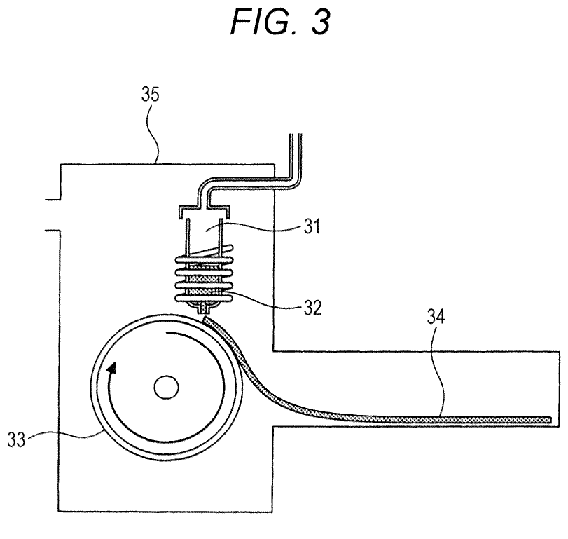

FIG. 3 shows a schematic diagram of a manufacturing device of a rapid cooling ribbon used in a single-roll method used in a single-roller melt-spinning method according to the present embodiment. In a chamber 35, a molten metal 32 is jetted and supplied as a continuous liquid from a nozzle 31 to a roll 33 rotating in a direction of an arrow through a slit at a bottom of the nozzle 31, whereby the molten metal 32 is rapidly cooled, and a ribbon 34 uniform in a rotation direction of the roll 33 is manufactured. In the present embodiment, a material of the roll 33 is, for example, Cu. An atmosphere in the chamber 35 is not particularly limited, but an atmosphere in an air atmosphere is particularly suitable for mass production.

The soft magnetic alloy ribbon 34 obtained by the above method may not include crystals having a particle diameter of more than 30 nm. The soft magnetic alloy ribbon 34 may have a structure including only amorphous material, or may have a nano-heterostructure in which crystals having a particle diameter of 30 nm or less exist in the amorphous material.

The method for confirming whether the soft magnetic alloy ribbon 34 includes crystals having a particle diameter larger than 30 nm is not particularly limited. For example, the presence or absence of crystals having a particle diameter larger than 30 nm can be confirmed by ordinary X-ray diffraction measurement. Alternatively, direct observation may be performed by using a transmission electron microscope.

The method for observing the presence or absence of the microcrystals and the mean particle diameter is not particularly limited, but can be confirmed, for example, by obtaining a selected area electron diffraction image, a nano beam diffraction image, a bright field image, or a high resolution image by using a transmission electron microscope for a sample that has been flaked by ion milling. When the selected area electron diffraction image or the nano beam diffraction image is used, ring-shaped diffraction is formed in a case of being an amorphous material in the diffraction pattern, whereas diffraction spots due to the crystal structure are formed in a case of not being an amorphous material. In addition, in a case of using a bright field image or a high resolution image, the presence or absence of microcrystals and the mean particle diameter can be observed by visual observation at a magnification of 1.00×10⁵ to 3.00×10⁵ times.

The heat treatment conditions for depositing nanocrystals, particularly Fe-based nanocrystals, are not particularly limited as long as the oxidation treatment of the surface of the soft magnetic alloy ribbon 34 does not proceed. Preferred heat treatment conditions vary depending on the composition of the soft magnetic alloy ribbon 34. Usually, a preferable heat treatment temperature is approximately 400 to 700° C., and a preferable heat treatment time is approximately 0.5 to 10 hours. However, depending on the composition, the preferable heat treatment temperature and heat treatment time may exist outside the above ranges. In addition, the heat treatment is preferably performed in an inert atmosphere such as an Ar gas or in a vacuum atmosphere in order to maintain the surface state of the soft magnetic alloy ribbon.

By performing the heat treatment in the inert atmosphere or in the vacuum atmosphere, Fe-based nanocrystals are deposited while maintaining the surface state. A soft magnetic alloy ribbon having good soft magnetic properties can be easily obtained by depositing Fe-based nanocrystals.

In general, when the soft magnetic alloy ribbon includes amorphous and does not include crystal, a saturation magnetic flux density tends to be high, and a coercivity tends to be higher than that of a nanocrystalline material.

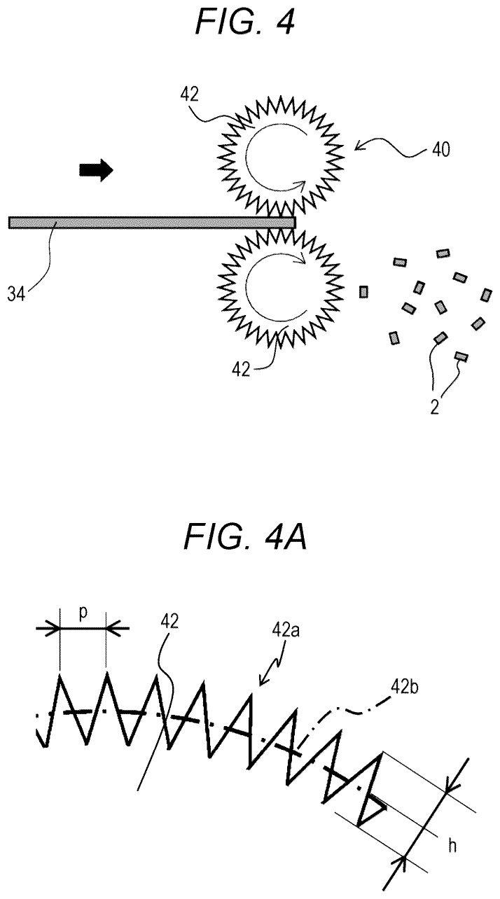

In the present embodiment, the amorphous and nanocrystalline soft magnetic alloy ribbon 34 is pulverized by a pulverizing device. The pulverizing device is not particularly limited as long as a desired circularity can be obtained. For example, a pulverizing device 40 illustrated in FIG. 4 is used. The pulverizing device 40 includes a pair of pulverizing rollers 42, and a pulverizing irregular surface is formed on a peripheral surface of the roller 42. The pulverizing irregular surface can be formed by, for example, knurling the peripheral surface of the roller 42.

For example, as shown in FIG. 4A, the irregularities of the pulverizing irregular surface 42a formed by knurling on the peripheral surface of each roller 42 are preferably regular irregularities, a height h of the irregularities is preferably 0.1 to 0.5 mm, and a pitch p of the irregularities in a circumferential direction (an axial direction is also the same) is preferably 0.5 to 2.0 mm.

These rollers 42 rotate in opposite directions to each other, sandwich the soft magnetic alloy ribbon 34 laminated in a single layer or a plurality of layers from both sides, and pulverize the ribbon 34 to manufacture the particles 2 to be the soft magnetic powder of the present embodiment. The shape of nanocrystals does not substantially change before and after pulverization. In addition, the thickness of the single-layer ribbon 34 corresponds to the thickness t of the particle 2 shown in FIG. 1C.

The particle 2 pulverized by being passed between the rollers 42 may be further pulverized by another pulverizing device or classified by a classifier. Examples of the another pulverizing device include a ball mill, a faculty, and a jet mill.

For example, the irregular state of the pulverizing irregular surface of the roller 42 illustrated in FIG. 4 is controlled. Alternatively, a gap between the pair of rollers 42 is adjusted. Alternatively, a drawing speed of the ribbon 34 between the rollers 42 is controlled. Alternatively, a processing time of the pulverizing device different from that in FIG. 4 is controlled. Alternatively, the classification condition is controlled. By incorporating these methods, a soft magnetic powder having the distribution of the present embodiment as shown in FIG. 2A is obtained.

In the present embodiment, in order to obtain the soft magnetic powder having the distribution of the present embodiment as shown in FIG. 2A, not FIG. 2B, the following method different from the related-art method is particularly adopted.

In the related-art coarse crush of the soft magnetic alloy ribbon 34, the soft magnetic alloy ribbon 34 is pulverized while freely moving like a feather mill. On the other hand, in the pulverizing device 40 in the present embodiment, the soft magnetic alloy ribbon 34 cannot freely move with respect to the roller, and the particle shape (circularity) of the coarse crushed powder can be controlled. A desired circularity can be obtained by using controlled coarse crush.

According to the soft magnetic powder according to the present embodiment, the relative permeability is improved by satisfying C1<C2 even when the composition of the soft magnetic powder is the same.

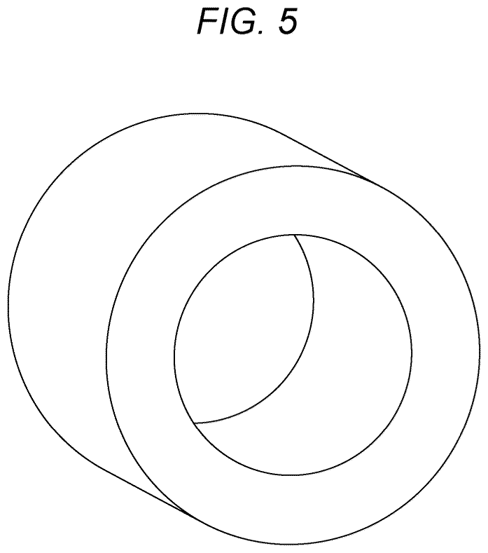

The application of the soft magnetic powder according to the above-described embodiment is not particularly limited. The soft magnetic powder according to the embodiment is used alone or in combination with another soft magnetic powder (for example, a particle that is not flat). For example, a magnetic core having a toroidal shape as illustrated in FIG. 5 may be manufactured, or a magnetic core or a magnetic component having another shape may be manufactured.

A wire may be wound around the magnetic core and used as an electronic component such as an inductor (particularly, a power device such as a power inductor) or a transformer. Alternatively, the soft magnetic powder according to the above-described embodiment can be used alone or mixed with another soft magnetic powder (for example, non-flat particle) to be used for a dust core incorporating a coil, or the like. Examples of other soft magnetic powders that may be mixed with the soft magnetic powder according to the above-described embodiment include, in addition to a soft magnetic powder manufactured by an atomization method, a soft magnetic powder manufactured by a spray pyrolysis method, a soft magnetic powder manufactured by a carbonyl method, and the like. Examples of the composition of the soft magnetic powder include, as the Fe-based crystalline based composition, Fe-based, Fe—Co based, Fe—Si based, Fe—Ni based, Fe—Ni—Mo based, Fe—Si—Cr based, Fe—Si—Al based, Fe—Si—Al—Ni based, Fe—Ni—Si—Co based, Fe-based amorphous based alloy compositions, or, as Fe-based nanocrystalline based alloy compositions, Fe—Nb—B—P—S based, Fe—Nb—B—Si—Cu based, Fe—Nb—B based, Fe—Si—B based, Fe—Si—Cr—B—C based, and Fe—Si—B—C based alloy compositions. By mixing the soft magnetic powder described above, a magnetic material packing density is further increased, and the permeability can be further improved.

The other soft magnetic powder that may be mixed with the soft magnetic powder according to the above-described embodiment may be a soft magnetic powder having a particle size and circularity that belong to the first particle group or the second particle group, or may be particles that do not belong thereto. That is, when it can be determined that the particles belong to the first particle group or the second particle group are mixed from the viewpoint of the composition and the circularity (shape), it may be determined that the particles do not belong to the first particle group or the second particle group. A proportion of the other soft magnetic powder is preferably about 30 mass % or less with respect to the mass of the entire powder including the soft magnetic powder according to the embodiment. In addition, a cross-sectional area of the magnetic core is preferably 30 area % or less with respect to the cross-sectional area occupied by the entire powder including the soft magnetic powder according to the embodiment.

Electronic components such as inductors are used by being incorporated in the electronic devices such as mobile phones and personal computers. Examples of the magnetic component other than the magnetic core include a thin film inductor, a magnetic head, a magnetic shielding sheet, and the like, and the magnetic component is used by being incorporated in the electronic device.

### Second Embodiment

Hereinafter, a method for obtaining a magnetic core and an inductor by using a soft magnetic powder will be described, but the method is not limited to the following method.

Examples of the molding method of the soft magnetic powder include a method in which the soft magnetic powder is mixed with a binder, a hardening agent, a catalyst, a solvent, or the like, and then molded by using a mold. Before mixing with the binder, the powder surface may be subjected to an oxidation treatment, an insulating film, or the like.

The molding method is not particularly limited, and examples thereof include molding by using a die and mold pressing. The type of the binder is not particularly limited, and examples thereof include an epoxy resin and a silicone resin. The solvent is determined according to a type of a resin and the like, and for example, acetone or the like is used. The mixing ratio of the soft magnetic powder and the binder is also not particularly limited. For example, 1 to 10 mass % of the binder is mixed with 100 mass % of the soft magnetic powder. Furthermore, the molded body forming the magnetic core may be subjected to the heat treatment after molding as a distortion elimination treatment.

In addition, an inductance component is obtained by applying a winding wire to the magnetic core. There is no particular limitation on the method of applying the winding wire and the method of manufacturing the inductance component. For example, a method of winding a wire around a magnetic core manufactured by the above method for at least one turn or more can be exemplified.

Furthermore, the soft magnetic powder may be pressure-molded and integrated in a state where a winding coil is incorporated in the magnetic material to manufacture the inductance component. In this case, it is easy to obtain an inductance component corresponding to a high frequency and a large current.

Furthermore, in a case of using a soft magnetic powder, a soft magnetic powder-containing paste obtained by adding a binder and a solvent to the soft magnetic powder to form a paste, and a conductor paste obtained by adding a binder and a solvent to a conductor metal for a coil to form a paste are alternately printed and laminated, and then heated and fired, whereby an inductance component can be obtained. Alternatively, an inductance component in which a coil is incorporated in a magnetic material can be obtained by preparing a soft magnetic sheet by using a soft magnetic powder-containing paste, printing a conductor paste on the surface of the soft magnetic sheet, and laminating and firing these.

The state of the soft magnetic powder in the magnetic core (dust core) can be confirmed, for example, by SEM observation of a cross section and analysis of the cross section. That is, planar polishing and image observation with a constant polishing thickness may be alternately repeated, and analysis may be performed by using serial sectioning in which a 3D image is constructed on a computer from the obtained continuous image. In addition, by cutting out a plurality of cross sections by a focused ion beam (FIB) to create a three-dimensional structural diagram and analyzing the three-dimensional structural diagram, it is possible to confirm a distribution related to the particle size and the circularity (for example, a distribution indicated in FIG. 2A) in the same manner as the soft magnetic powder.

In addition, in the magnetic core (dust core) obtained in this manner, the existence ratio (area proportion) of particles of 160 μm or more in the used soft magnetic powder can be obtained from cross-sectional observation of the core. In addition, from the area proportion obtained from the cross-sectional observation of the core, the existence ratio (volume proportion and mass proportion) of particles of 160 μm or more in the soft magnetic powder can also be obtained by conversion.

In a case of the magnetic core, the soft magnetic powder of the present embodiment may be evaluated with 1000 or more pieces, and in order to evaluate in more detail, the number of the soft magnetic powder is preferably 20,000 or more.

Further, when the cross-sectional area occupied by the particles having a particle size of 160 μm or more is 30% or more of the cross-sectional areas occupied by the particles belonging to the first particle group and the second particle group in the cross section of the magnetic core, the volume occupied by the particles having a particle size of 160 μm or more may be 30% or more. In addition, the first particle group and the second particle group in the cross section can be separately evaluated by analyzing the magnetic powder in the cross section. Specifically, in a case of observing the cross section of the magnetic core, an average value of the circularities of the particles of D70 or more of the magnetic particles belonging to the cross section may be C1′, an average value of the circularities of the particles of D30 or less may be C2′, a relationship C1<C2 of the circularity of each of the first particle group and the second particle group belonging to the magnetic core may be confirmed with the confirmation of a relationship C1′<C2′, and when C1′<C2′, C1<C2 may be satisfied.

In the embodiment described above, the soft magnetic alloy ribbon is heat-treated in an inert atmosphere such as Ar to crystallize the soft magnetic alloy ribbon, but the composition of the finally obtained soft magnetic powder may be various compositions such as amorphous material or nanocrystals, and crystallization by the heat treatment is not necessarily performed. The heat treatment may be performed after pulverization.

### EXAMPLES

Hereinafter, the present invention will be described based on more detailed examples, but the present invention is not limited to these examples.

### Experimental Example 1

Raw materials were weighed so as to have the alloy composition shown in Table 1, and melted by high-frequency heating to prepare a base alloy. Thereafter, the prepared base alloy was heated and melted to form a metal in a molten state at 1100 to 1600° C. in accordance with the alloy composition by using, for example, a device shown in FIG. 3, and then the metal was injected onto the roll 33 by a single-roller melt-spinning method to prepare a ribbon. The material of the roll 33 was Cu. A ribbon having a thickness of 20 to 30 μm and a width of 50 mm was obtained. Thereafter, the ribbon was subjected to a heat treatment at a heat treatment temperature of 200 to 650° C. for 10 to 300 minutes in accordance with the alloy composition in an Ar atmosphere (oxygen concentration: 10 ppm or less).

The ribbon was subjected to X-ray diffraction measurement to measure the amorphization ratio X. When the amorphization ratio X was 85% or more, it was defined as being composed of amorphous material. In addition, in a case of amorphous material, measurement was performed by using a transmission electron microscope to determine whether the structure is a nano-heterostructure (heteroamorphous structure). When the amorphization ratio X was less than 85% and the average crystal grain size was smaller than 30 nm, it was defined as being composed of nanocrystals. When the amorphization ratio X was less than 85% and the average crystal grain size was larger than 30 nm, it was defined as being composed of crystals. It was confirmed that the ribbon was composed of a heteroamorphous structure or nanocrystals.

In sample Nos. 1 and 2, the ribbons were coarsely crushed by using a feather mill manufactured by Hosokawa Micron Corporation, and then additionally pulverized by using a pin mill. Thereafter, refinement and circularity adjustment of the particles 2 were performed by using a dry attritor in the sample No. 1 and by using a ball mill in the sample No. 2.

In the sample Nos. 3 to 5, the obtained ribbons were laminated in 20 layers, introduced at a predetermined speed between two roll mills (pulverizing rollers 42 shown in FIG. 4) having a gap shown in the table, and a pressure was applied to coarsely crush the ribbons. At this time, on the surface of the roller 42 shown in FIG. 4A, a roll mill was used in which the pulverizing irregular surface 42a of twill weave was formed in which the pitch p of 0.2 mm and the irregular heights h of 0.85 mm. The gap is a distance between central reference planes for irregularities 42b of the pulverizing irregular surface 42a formed on the peripheral surface of each roller 42.

Thereafter, classification was performed with a classification filter described in the table to obtain a sample of the soft magnetic powder. It was confirmed by ICP analysis that the composition of the base alloy and the composition of the soft magnetic powder were almost the same. In addition, it was confirmed by X-ray diffraction measurement or observation with a transmission electron microscope that the soft magnetic powder had a heteroamorphous structure or nanocrystals.

In the classification in the table, a numerical value of a mesh pass and a numerical value of a mesh on mean that, a powder that has passed through the mesh using the mesh of each aperture is the powder that has passed through the mesh, and a powder that has not passed through the mesh is the mesh on powder. For example, in a case of mesh pass of 300 μm and a mesh on of 72 μm, it means that the powder has passed through 300 μm but has not passed through 72 μm. The D50 of the powder thus obtained is 72 μm or more and 300 μm or less.

The sample of the obtained soft magnetic powder was evaluated as follows.

The particle shape of each of the obtained soft magnetic powders was evaluated. The particle shape was evaluated by measuring the average particle size and the average circularity on the number basis. For the average particle size and the average circularity on the number basis, the particle size and the circularity of each powder particle were measured by observing the shape of 20,000 powder particles at a magnification of 10 times by the method described above by using the Mophorogi G3 (Malvern Paralytical). Specifically, a soft magnetic alloy powder having a volume of 3 cc was dispersed at an air pressure of 1 to 3 bar, and a projection image by a laser microscope was photographed.

Then, the first average circularity C1 of each particle having a particle size of D50 or more and the second average circularity C2 of each particle having a particle size of less than D50 were obtained. The results are shown in Table 1.

Next, for example, a toroidal core shown in FIG. 5 was prepared from each soft magnetic powder. Specifically, an epoxy resin as a binder was mixed with each soft magnetic powder so as to be 3 mass % of the whole, and granulated by using a general planetary mixer as an agitator. Next, the obtained granulated powder was molded at a surface pressure of 8000 kgf/cm² to prepare a toroidal shaped molded body having an outer diameter of 11 mm, an inner diameter of 6.5 mm, and a height of 3.0 mm. The obtained molded body was hardened at 110 to 180° C. for 2 hours to prepare a toroidal core.

Then, a UEW wire was wound around the toroidal core, and μ (permeability) at 1 MHz was measured with an impedance analyzer E4990A manufactured by KEYSIGHT. The results are shown in Table 1.

In addition, it has been confirmed that the soft magnetic powder in the toroidal core also has a circularity distribution with respect to the same particle size in the state of the soft magnetic powder of the raw material by sequentially observing the cross section of the obtained toroidal core and creating and analyzing the three-dimensional structure diagram.

TABLE 1

| | | | | | | | | Average | Average | | |
|---|---|---|---|---|---|---|---|---|---|---|---|
| | | | | | | | | value | value | | |
| | | | | | | | | C1 of | C2 of | | |
| | | | | Roll mill | | Classification | | circu- | circu- | | |
| | Example/ | | | | Conveying | Mesh | Mesh | larities | larities | | Relative |
| Sample | Comparative | Material | | Gap | speed | pass | on | of D50 | of less | | perme- |
| No. | Example | system | Composition | (mm) | (cm/s) | (um) | (um) | or more | than | C1/C2 | ability |
| 1 | Comparative | Nanocrystal | Fe73.5Si13.5B9Nb3Cu1 | Feather mill + attritor | | 300 | 72 | 0.83 | 0.78 | 1.06 | 38 |
| | Example | | | | | | | | | | |
| 2 | Comparative | Nanocrystal | Fe73.5Si13.5B9Nb3Cu1 | Feather mill + ball mill | | 300 | 72 | 0.86 | 0.86 | 1.00 | 39 |
| | Example | | | | | | | | | | |
| 3 | Example | Nanocrystal | Fe73.5Si13.5B9Nb3Cu1 | 0.32 | 2.0 | 300 | 72 | 0.79 | 0.83 | 0.95 | 49 |
| 4 | Example | Nanocrystal | Fe73.5Si13.5B9Nb3Cu1 | 0.32 | 1.0 | 300 | 72 | 0.76 | 0.79 | 0.96 | 44 |
| 5 | Comparative | Nanocrystal | Fe73.5Si13.5B9Nb3Cu1 | 0.32 | 0.5 | 300 | 72 | 0.84 | 0.78 | 1.08 | 39 |
| | Example | | | | | | | | | | |

Evaluation

As shown in Table 1, it was confirmed that the soft magnetic powders of Examples satisfying C1<C2 (in addition, C1/C2 is 0.96 or less) exhibited a high permeability (1.1 times or more) than the soft magnetic powders of Comparative Examples (C1>C2 and C1/C2 is 1.00 or more) while having the same composition.

### Experimental Example 2

As shown in Table 2, a soft magnetic powder was prepared in the same manner as for sample No. 3 in Experimental Example 1 except that the conditions at the time of pulverization were adjusted in order to adjust the gradient A of the approximate straight line obtained from the circularity distribution with respect to the particle size, and the particles were coarsely crushed, and then pulverized in a ball mill for a time described in Table 2 by using zirconia beads having an outer diameter of 0.4 to 0.6 mm in order to adjust the refinement and the circularity of the particles. It is to be noted that samples not subjected to the ball mill treatment were indicated as “-” in the table. Thereafter, C1 and C2 were obtained in the same manner as in Experimental Example 1, and in addition, the gradient A in the formula of the approximate straight line was measured. In addition, a toroidal core was prepared in the same manner as in Experimental Example 1, and the relative permeability was measured. The results are shown in Table 2.

TABLE 2

| | | | | | | | | | Average | Average | | | |
|---|---|---|---|---|---|---|---|---|---|---|---|---|---|
| | | | | | | Ball | | | value | value | | | |
| | | | | Roll mill | | mill | | | C1 of | C2 of | | | |
| | Example/ | | | | Con- | Pulver- | Classification | | circu- | circu- | | | Rela- |
| | Compar- | Mate- | | | veying | izing | Mesh | Mesh | larities | larities | | | tive |
| Sample | ative | rial | | Gap | speed | time | pass | on | of D50 | of less | C1/ | Gradient | perme- |
| No. | Example | system | Composition | (mm) | (cm/s) | (h) | (um) | (um) | or more | than D50 | C2 | (um −1) | ability |
| 6 | Example | Nano- | Fe73.5Si13.5B9Nb3Cu1 | 0.32 | 6.0 | 24 | 300 | 72 | 0.67 | 0.84 | 0.80 | −0.00130 | 43 |
| | | crystal | | | | | | | | | | | |
| 7 | Example | Nano- | Fe73.5Si13.5B9Nb3Cu1 | 0.32 | 4.0 | 24 | 300 | 72 | 0.72 | 0.85 | 0.85 | −0.00094 | 46 |
| | | crystal | | | | | | | | | | | |
| 8 | Example | Nano- | Fe73.5Si13.5B9Nb3Cu1 | 0.32 | 3.0 | 24 | 300 | 72 | 0.79 | 0.86 | 0.92 | −0.00058 | 51 |
| | | crystal | | | | | | | | | | | |
| 9 | Example | Nano- | Fe73.5Si13.5B9Nb3Cu1 | 0.32 | 2.0 | 24 | 300 | 72 | 0.81 | 0.86 | 0.94 | −0.00038 | 53 |
| | | crystal | | | | | | | | | | | |
| 10 | Example | Nano- | Fe73.5Si13.5B9Nb3Cu1 | 0.32 | 1.0 | 24 | 300 | 72 | 0.77 | 0.82 | 0.94 | −0.00020 | 49 |
| | | crystal | | | | | | | | | | | |
| 11 | Example | Nano- | Fe73.5Si13.5B9Nb3Cu1 | 0.32 | 0.8 | 24 | 300 | 72 | 0.79 | 0.82 | 0.96 | −0.00010 | 45 |
| | | crystal | | | | | | | | | | | |
| 12 | Example | Nano- | Fe73.5Si13.5B9Nb3Cu1 | 0.32 | 0.6 | 24 | 300 | 72 | 0.81 | 0.82 | 0.99 | −0.00005 | 41 |
| | | crystal | | | | | | | | | | | |
| 13 | Compar- | Nano- | Fe73.5Si13.5B9Nb3Cu1 | 0.32 | 0.5 | 24 | 300 | 72 | 0.88 | 0.82 | 1.07 | 0.00203 | 37 |
| | ative | crystal | | | | | | | | | | | |
| | Example | | | | | | | | | | | | |

Evaluation

As shown in Table 2, it was confirmed that the soft magnetic powders of Examples satisfying C1<C2 (in addition, C1/C2 is 0.99 or less) exhibited a high permeability (1.1 times or more) than the soft magnetic powder of Comparative Example (C1>C2 and C1/C2 is 1.07) while having the same composition.

In addition, as shown in Table 2, by comparing Examples of sample Nos. 6 to 12, it has been confirmed that the gradient A of the approximate straight line obtained from the circularity distribution with respect to the particle size is preferably −0.0015/μm or more, more preferably −0.0006/μm or more, or preferably −0.0001/μm or less, more preferably −0.0004/μm or less, and there is a tendency that a higher permeability is exhibited.

### Experimental Example 3

As shown in Table 3, the soft magnetic powder was prepared in the same manner as in Experimental Example 2 except that the conditions at the time of pulverization were adjusted. Thereafter, C1 and C2 were obtained in the same manner as in Experimental Example 1, and in addition, the gradient A and the dispersion σ² (mean square error) of the distribution in the formula of the approximate straight line were measured. In addition, a toroidal core was prepared in the same manner as in Experimental Example 2, and the relative permeability was measured. The results are shown in Table 3.

TABLE 3

| | | | | Roll mill | | Ball mill | Classification | |
|---|---|---|---|---|---|---|---|---|
| | Example/ | | | | Conveying | Pulverizing | Mesh | Mesh |
| Sample | Comparative | Material | | Gap | speed | time | pass | on |
| No. | Example | system | Composition | (mm) | (cm/s) | (h) | (um) | (um) |
| 14 | Example | Nanocrystal | Fe73.5Si13.5B9Nb3Cu1 | 0.32 | 2.0 | 72 | 300 | 72 |
| 15 | Example | Nanocrystal | Fe73.5Si13.5B9Nb3Cu1 | 0.32 | 2.0 | 36 | 300 | 72 |
| 9 | Example | Nanocrystal | Fe73.5Si13.5B9Nb3Cu1 | 0.32 | 2.0 | 24 | 300 | 72 |
| 16 | Example | Nanocrystal | Fe73.5Si13.5B9Nb3Cu1 | 0.32 | 2.0 | 16 | 300 | 72 |
| 17 | Example | Nanocrystal | Fe73.5Si13.5B9Nb3Cu1 | 0.32 | 2.0 | 8 | 300 | 72 |
| 3 | Example | Nanocrystal | Fe73.5Si13.5B9Nb3Cu1 | 0.32 | 2.0 | — | 300 | 72 |
| 18 | Example | Nanocrystal | Fe73.5Si13.5B9Nb3Cu1 | 0.32 | 1.0 | 72 | 300 | 72 |
| 19 | Example | Nanocrystal | Fe73.5Si13.5B9Nb3Cu1 | 0.32 | 1.0 | 36 | 300 | 72 |
| 10 | Example | Nanocrystal | Fe73.5Si13.5B9Nb3Cu1 | 0.32 | 1.0 | 24 | 300 | 72 |
| 20 | Example | Nanocrystal | Fe73.5Si13.5B9Nb3Cu1 | 0.32 | 1.0 | 16 | 300 | 72 |
| 21 | Example | Nanocrystal | Fe73.5Si13.5B9Nb3Cu1 | 0.32 | 1.0 | 8 | 300 | 72 |
| 4 | Example | Nanocrystal | Fe73.5Si13.5B9Nb3Cu1 | 0.32 | 1.0 | — | 300 | 72 |
| 22 | Comparative | Nanocrystal | Fe73.5Si13.5B9Nb3Cu1 | 0.32 | 0.5 | 72 | 300 | 72 |
| | Example | | | | | | | |
| 23 | Comparative | Nanocrystal | Fe73.5Si13.5B9Nb3Cu1 | 0.32 | 0.5 | 36 | 300 | 72 |
| | Example | | | | | | | |
| 13 | Comparative | Nanocrystal | Fe73.5Si13.5B9Nb3Cu1 | 0.32 | 0.5 | 24 | 300 | 72 |
| | Example | | | | | | | |
| 24 | Comparative | Nanocrystal | Fe73.5Si13.5B9Nb3Cu1 | 0.32 | 0.5 | 16 | 300 | 72 |
| | Example | | | | | | | |
| 25 | Comparative | Nanocrystal | Fe73.5Si13.5B9Nb3Cu1 | 0.32 | 0.5 | 8 | 300 | 72 |
| | Example | | | | | | | |
| 5 | Comparative | Nanocrystal | Fe73.5Si13.5B9Nb3Cu1 | 0.32 | 0.5 | — | 300 | 72 |
| | Example | | | | | | | |

| | Average | Average | | | | |
|---|---|---|---|---|---|---|
| | value | value | | | | |
| | C1 of | C2 of | | | | |
| | circularities | circularities | | | | |
| Sample | of D50 | of less | | Gradient | | Relative |
| No. | or more | than D50 | C1/C2 | (um −1) | Dispersion | permeability |
| 14 | 0.80 | 0.85 | 0.94 | −0.00039 | 0.0020 | 45 |
| 15 | 0.81 | 0.85 | 0.95 | −0.00041 | 0.0058 | 50 |
| 9 | 0.81 | 0.86 | 0.94 | −0.00038 | 0.0080 | 53 |
| 16 | 0.77 | 0.82 | 0.94 | −0.00040 | 0.0095 | 53 |
| 17 | 0.77 | 0.81 | 0.95 | −0.00041 | 0.0149 | 54 |
| 3 | 0.79 | 0.83 | 0.95 | −0.00038 | 0.0399 | 49 |
| 18 | 0.82 | 0.85 | 0.96 | −0.00020 | 0.0021 | 43 |
| 19 | 0.81 | 0.84 | 0.96 | −0.00021 | 0.0060 | 46 |
| 10 | 0.77 | 0.82 | 0.94 | −0.00020 | 0.0081 | 49 |
| 20 | 0.77 | 0.81 | 0.95 | −0.00020 | 0.0103 | 49 |
| 21 | 0.78 | 0.81 | 0.96 | −0.00020 | 0.0148 | 50 |
| 4 | 0.76 | 0.79 | 0.96 | −0.00020 | 0.0389 | 44 |
| 22 | 0.84 | 0.79 | 1.06 | 0.00192 | 0.0021 | 38 |
| 23 | 0.81 | 0.77 | 1.05 | 0.00209 | 0.0060 | 38 |
| 13 | 0.88 | 0.82 | 1.07 | 0.00203 | 0.0078 | 37 |
| 24 | 0.84 | 0.78 | 1.08 | 0.00210 | 0.0097 | 38 |
| 25 | 0.86 | 0.81 | 1.06 | 0.00199 | 0.0121 | 38 |
| 5 | 0.84 | 0.78 | 1.08 | 0.00207 | 0.0378 | 39 |

Evaluation

As shown in Table 3, it was confirmed that the soft magnetic powders of Examples satisfying C1<C2 exhibited a high permeability (1.1 times or more) than the soft magnetic powders of Comparative Examples (C1>C2 and C1/C2 is 1.05 or more) while having the same composition.

In addition, as shown in Table 3, by comparing Examples of sample Nos. 14, 15, 9, 16, 17, and 3, it has been confirmed that when the gradients A of the approximate straight lines obtained from the circularity distribution with respect to the particle size are similar, in a case where the dispersion σ² of the circularity distribution satisfies a predetermined range, the permeability tends to be further higher. The same was confirmed by comparing Examples of sample Nos. 18, 19, 10, 20, 21, and 4. From these results, it has been confirmed that the dispersion of the circularity distribution is preferably 0.002 or more and 0.040 or less, and more preferably 0.005 or more and 0.015 or less. It is considered that the filling property is improved and the permeability is improved.

### Experimental Example 4

As shown in Table 4, the soft magnetic powder was prepared in the same manner as in Experimental Example 3 except that the conditions at the time of pulverization were adjusted. Thereafter, similarly to Experimental Example 3, the gradient A of the approximate straight line obtained from the circularity distribution with respect to C1, C2, and the particle size and the dispersion σ² (mean square error) of the circularity distribution were obtained, and in addition, the third average circularity C3 of the particle group of D45 or more and less than D55 was obtained. In addition, a toroidal core was prepared in the same manner as in Experimental Example 3, and the relative permeability was measured. The results are shown in Table 4.

TABLE 4

| | | | | Roll mill | | Ball mill | Classification | |
|---|---|---|---|---|---|---|---|---|
| | Example/ | | | | Conveying | Pulverizing | Mesh | Mesh |
| Sample | Comparative | Material | | Gap | speed | time | pass | on |
| No. | Example | system | Composition | (mm) | (cm/s) | (h) | (um) | (um) |
| 26 | Example | Nanocrystal | Fe73.5Si13.5B9Nb3Cu1 | 0.38 | 2.0 | 72 | 300 | 72 |
| 27 | Example | Nanocrystal | Fe73.5Si13.5B9Nb3Cu1 | 0.36 | 2.0 | 72 | 300 | 72 |
| 28 | Example | Nanocrystal | Fe73.5Si13.5B9Nb3Cu1 | 0.34 | 2.0 | 72 | 300 | 72 |
| 14 | Example | Nanocrystal | Fe73.5Si13.5B9Nb3Cu1 | 0.32 | 2.0 | 72 | 300 | 72 |
| 29 | Example | Nanocrystal | Fe73.5Si13.5B9Nb3Cu1 | 0.30 | 2.0 | 72 | 300 | 72 |
| 30 | Example | Nanocrystal | Fe73.5Si13.5B9Nb3Cu1 | 0.28 | 2.0 | 72 | 300 | 72 |
| 31 | Example | Nanocrystal | Fe73.5Si13.5B9Nb3Cu1 | 0.38 | 2.0 | 36 | 300 | 72 |
| 32 | Example | Nanocrystal | Fe73.5Si13.5B9Nb3Cu1 | 0.36 | 2.0 | 36 | 300 | 72 |
| 33 | Example | Nanocrystal | Fe73.5Si13.5B9Nb3Cu1 | 0.34 | 2.0 | 36 | 300 | 72 |
| 15 | Example | Nanocrystal | Fe73.5Si13.5B9Nb3Cu1 | 0.32 | 2.0 | 36 | 300 | 72 |
| 34 | Example | Nanocrystal | Fe73.5Si13.5B9Nb3Cu1 | 0.30 | 2.0 | 36 | 300 | 72 |
| 35 | Example | Nanocrystal | Fe73.5Si13.5B9Nb3Cu1 | 0.28 | 2.0 | 36 | 300 | 72 |
| 36 | Example | Nanocrystal | Fe73.5Si13.5B9Nb3Cu1 | 0.38 | 2.0 | 8 | 300 | 72 |
| 37 | Example | Nanocrystal | Fe73.5Si13.5B9Nb3Cu1 | 0.36 | 2.0 | 8 | 300 | 72 |
| 38 | Example | Nanocrystal | Fe73.5Si13.5B9Nb3Cu1 | 0.34 | 2.0 | 8 | 300 | 72 |
| 17 | Example | Nanocrystal | Fe73.5Si13.5B9Nb3Cu1 | 0.32 | 2.0 | 8 | 300 | 72 |
| 39 | Example | Nanocrystal | Fe73.5Si13.5B9Nb3Cu1 | 0.30 | 2.0 | 8 | 300 | 72 |
| 40 | Example | Nanocrystal | Fe73.5Si13.5B9Nb3Cu1 | 0.28 | 2.0 | 8 | 300 | 72 |
| 41 | Comparative | Nanocrystal | Fe73.5Si13.5B9Nb3Cu1 | 0.38 | 0.5 | 72 | 300 | 72 |
| | Example | | | | | | | |
| 42 | Comparative | Nanocrystal | Fe73.5Si13.5B9Nb3Cu1 | 0.36 | 0.5 | 72 | 300 | 72 |
| | Example | | | | | | | |
| 43 | Comparative | Nanocrystal | Fe73.5Si13.5B9Nb3Cu1 | 0.34 | 0.5 | 72 | 300 | 72 |
| | Example | | | | | | | |
| 22 | Comparative | Nanocrystal | Fe73.5Si13.5B9Nb3Cu1 | 0.32 | 0.5 | 72 | 300 | 72 |
| | Example | | | | | | | |
| 44 | Comparative | Nanocrystal | Fe73.5Si13.5B9Nb3Cu1 | 0.30 | 0.5 | 72 | 300 | 72 |
| | Example | | | | | | | |
| 45 | Comparative | Nanocrystal | Fe73.5Si13.5B9Nb3Cu1 | 0.28 | 0.5 | 72 | 300 | 72 |
| | Example | | | | | | | |
| 46 | Comparative | Nanocrystal | Fe73.5Si13.5B9Nb3Cu1 | 0.38 | 0.5 | 36 | 300 | 72 |
| | Example | | | | | | | |
| 47 | Comparative | Nanocrystal | Fe73.5Si13.5B9Nb3Cu1 | 0.36 | 0.5 | 36 | 300 | 72 |
| | Example | | | | | | | |
| 48 | Comparative | Nanocrystal | Fe73.5Si13.5B9Nb3Cu1 | 0.34 | 0.5 | 36 | 300 | 72 |
| | Example | | | | | | | |
| 23 | Comparative | Nanocrystal | Fe73.5Si13.5B9Nb3Cu1 | 0.32 | 0.5 | 36 | 300 | 72 |
| | Example | | | | | | | |
| 49 | Comparative | Nanocrystal | Fe73.5Si13.5B9Nb3Cu1 | 0.30 | 0.5 | 36 | 300 | 72 |
| | Example | | | | | | | |
| 50 | Comparative | Nanocrystal | Fe73.5Si13.5B9Nb3Cu1 | 0.28 | 0.5 | 36 | 300 | 72 |
| | Example | | | | | | | |
| 51 | Comparative | Nanocrystal | Fe73.5Si13.5B9Nb3Cu1 | 0.38 | 0.5 | 8 | 300 | 72 |
| | Example | | | | | | | |
| 52 | Comparative | Nanocrystal | Fe73.5Si13.5B9Nb3Cu1 | 0.36 | 0.5 | 8 | 300 | 72 |
| | Example | | | | | | | |
| 53 | Comparative | Nanocrystal | Fe73.5Si13.5B9Nb3Cu1 | 0.34 | 0.5 | 8 | 300 | 72 |
| | Example | | | | | | | |
| 25 | Comparative | Nanocrystal | Fe73.5Si13.5B9Nb3Cu1 | 0.32 | 0.5 | 8 | 300 | 72 |
| | Example | | | | | | | |
| 54 | Comparative | Nanocrystal | Fe73.5Si13.5B9Nb3Cu1 | 0.30 | 0.5 | 8 | 300 | 72 |
| | Example | | | | | | | |
| 55 | Comparative | Nanocrystal | Fe73.5Si13.5B9Nb3Cu1 | 0.28 | 0.5 | 8 | 300 | 72 |
| | Example | | | | | | | |

| | Average | Average | | | | | |
|---|---|---|---|---|---|---|---|
| | value of | value of | | | | Average of | |
| | circularities | circularities | | | | circularities | |
| Sample | of D50 | of less | | Gradient | | of D45 | Relative |
| No. | or more | than D50 | C1/C2 | (um −1) | Dispersion | to D55 | permeability |
| 26 | 0.66 | 0.71 | 0.93 | −0.00042 | 0.0020 | 0.68 | 42 |
| 27 | 0.69 | 0.72 | 0.96 | −0.00041 | 0.0020 | 0.71 | 43 |
| 28 | 0.71 | 0.75 | 0.95 | −0.00039 | 0.0021 | 0.74 | 45 |
| 14 | 0.80 | 0.85 | 0.94 | −0.00039 | 0.0020 | 0.83 | 45 |
| 29 | 0.84 | 0.90 | 0.93 | −0.00039 | 0.0021 | 0.85 | 45 |
| 30 | 0.89 | 0.96 | 0.93 | −0.00040 | 0.0019 | 0.92 | 43 |
| 31 | 0.61 | 0.64 | 0.95 | −0.00040 | 0.0056 | 0.62 | 45 |
| 32 | 0.68 | 0.72 | 0.94 | −0.00041 | 0.0057 | 0.70 | 45 |
| 33 | 0.73 | 0.78 | 0.94 | −0.00041 | 0.0055 | 0.75 | 49 |
| 15 | 0.81 | 0.85 | 0.95 | −0.00041 | 0.0058 | 0.82 | 50 |
| 34 | 0.84 | 0.89 | 0.94 | −0.00042 | 0.0056 | 0.85 | 49 |
| 35 | 0.87 | 0.91 | 0.96 | −0.00042 | 0.0054 | 0.89 | 46 |
| 36 | 0.65 | 0.68 | 0.96 | −0.00041 | 0.0133 | 0.66 | 48 |
| 37 | 0.67 | 0.71 | 0.94 | −0.00042 | 0.0137 | 0.68 | 48 |
| 38 | 0.75 | 0.79 | 0.95 | −0.00042 | 0.0133 | 0.78 | 52 |
| 17 | 0.77 | 0.81 | 0.95 | −0.00041 | 0.0149 | 0.79 | 54 |
| 39 | 0.81 | 0.84 | 0.96 | −0.00039 | 0.0146 | 0.83 | 54 |
| 40 | 0.83 | 0.87 | 0.95 | −0.00041 | 0.0146 | 0.86 | 49 |
| 41 | 0.65 | 0.63 | 1.03 | 0.00196 | 0.0019 | 0.64 | 38 |
| 42 | 0.71 | 0.70 | 1.01 | 0.00205 | 0.0021 | 0.71 | 38 |
| 43 | 0.74 | 0.72 | 1.03 | 0.00193 | 0.0021 | 0.73 | 38 |
| 22 | 0.84 | 0.79 | 1.06 | 0.00192 | 0.0021 | 0.81 | 38 |
| 44 | 0.89 | 0.89 | 1.00 | 0.00192 | 0.0021 | 0.89 | 38 |
| 45 | 0.89 | 0.85 | 1.05 | 0.00191 | 0.0020 | 0.87 | 33 |
| 46 | 0.64 | 0.62 | 1.03 | 0.00197 | 0.0059 | 0.63 | 38 |
| 47 | 0.68 | 0.66 | 1.03 | 0.00191 | 0.0058 | 0.67 | 37 |
| 48 | 0.77 | 0.75 | 1.03 | 0.00192 | 0.0061 | 0.75 | 38 |
| 23 | 0.81 | 0.77 | 1.05 | 0.00209 | 0.0060 | 0.80 | 38 |
| 49 | 0.83 | 0.80 | 1.04 | 0.00205 | 0.0061 | 0.81 | 38 |
| 50 | 0.88 | 0.85 | 1.04 | 0.00199 | 0.0058 | 0.86 | 38 |
| 51 | 0.67 | 0.67 | 1.00 | 0.00192 | 0.0124 | 0.67 | 37 |
| 52 | 0.67 | 0.65 | 1.03 | 0.00203 | 0.0125 | 0.67 | 37 |
| 53 | 0.78 | 0.75 | 1.04 | 0.00202 | 0.0126 | 0.77 | 37 |
| 25 | 0.86 | 0.81 | 1.06 | 0.00199 | 0.0121 | 0.82 | 38 |
| 54 | 0.84 | 0.82 | 1.02 | 0.00209 | 0.0121 | 0.83 | 39 |
| 55 | 0.94 | 0.91 | 1.03 | 0.00194 | 0.0126 | 0.93 | 38 |

Evaluation

As shown in Table 4, it was confirmed that the soft magnetic powders of Examples satisfying C1<C2 exhibited a high permeability (1.1 times or more) than the soft magnetic powders of Comparative Examples (C1>C2 and C1/C2 is 1.00 or more) while having the same composition.

Further, as shown in Table 4, it has been confirmed that when the gradient of the distribution and the dispersion σ² (mean square error) are almost the same, in a case where the third average circularity C3 of the particle group of D45 or more and less than D55 satisfies a predetermined range, a higher relative permeability tends to be exhibited.

### Experimental Example 5

As shown in Table 5, the soft magnetic powder was prepared in the same manner as in Experimental Example 3 except that the gap and a conveying speed of the roll mill were adjusted, and the existence ratio of particles having a particle size of 160 μm or more was controlled by further changing the classification conditions. In addition to obtaining the gradient A and the dispersion σ² (mean square error) in the formula of the approximate straight line, the existence ratio (volume ratio) of C3 and particles having a particle size of 160 μm or more was measured. Then, a toroidal core was prepared in the same manner as in Experimental Example 3, and the relative permeability was measured. The results are shown in Table 5. In addition, from the cross-sectional observation of the toroidal core, the existence ratio (area ratio) of particles having a particle size of 160 μm or more was calculated, and the existence ratio in volume ratio was calculated from the area ratio to obtain the existence ratio (volume ratio) of the particles having a particle size of 160 μm or more in the state of the soft magnetic powder of the raw material. The existence ratio of the mass ratio can also be obtained from the existence ratio of the volume ratio.

TABLE 5

| | | | | | | | | | Average |
|---|---|---|---|---|---|---|---|---|---|
| | | | | | | | | | value of |
| | Example/ | | | Roll mill | | Ball mill | Classification | | circu- |
| | Compar- | Mate- | | | Conveying | Pulverizing | Mesh | Mesh | larities |
| Sample | ative | rial | | Gap | speed | time | pass | on | of D50 |
| No. | Example | system | Composition | (mm) | (cm/s) | (h) | (um) | (um) | or more |
| 56 | Comparative | Nano- | Fe73.5Si13.5B9Nb3Cu1 | 0.38 | 0.5 | 8 | 180 | 20 | 0.62 |
| | Example | crystal | | | | | | | |
| 57 | Example | Nano- | Fe73.5Si13.5B9Nb3Cu1 | 0.38 | 2.0 | 8 | 180 | 20 | 0.61 |
| | | crystal | | | | | | | |
| 58 | Comparative | Nano- | Fe73.5Si13.5B9Nb3Cu1 | 0.38 | 0.5 | 8 | 180 | 25 | 0.63 |
| | Example | crystal | | | | | | | |
| 59 | Example | Nano- | Fe73.5Si13.5B9Nb3Cu1 | 0.38 | 2.0 | 8 | 180 | 25 | 0.60 |
| | | crystal | | | | | | | |
| 60 | Comparative | Nano- | Fe73.5Si13.5B9Nb3Cu1 | 0.38 | 0.5 | 8 | 180 | 38 | 0.62 |
| | Example | crystal | | | | | | | |
| 61 | Example | Nano- | Fe73.5Si13.5B9Nb3Cu1 | 0.38 | 2.0 | 8 | 180 | 38 | 0.60 |
| | | crystal | | | | | | | |
| 62 | Comparative | Nano- | Fe73.5Si13.5B9Nb3Cu1 | 0.38 | 0.5 | 8 | 180 | 45 | 0.62 |
| | Example | crystal | | | | | | | |
| 63 | Example | Nano- | Fe73.5Si13.5B9Nb3Cu1 | 0.38 | 2.0 | 8 | 180 | 45 | 0.62 |
| | | crystal | | | | | | | |
| 64 | Comparative | Nano- | Fe73.5Si13.5B9Nb3Cu1 | 0.38 | 0.5 | 8 | 180 | 72 | 0.67 |
| | Example | crystal | | | | | | | |
| 65 | Example | Nano- | Fe73.5Si13.5B9Nb3Cu1 | 0.38 | 2.0 | 8 | 180 | 72 | 0.63 |
| | | crystal | | | | | | | |
| 66 | Comparative | Nano- | Fe73.5Si13.5B9Nb3Cu1 | 0.38 | 0.5 | 8 | 355 | 106 | 0.64 |
| | Example | crystal | | | | | | | |
| 67 | Example | Nano- | Fe73.5Si13.5B9Nb3Cu1 | 0.38 | 2.0 | 8 | 355 | 106 | 0.62 |
| | | crystal | | | | | | | |
| 68 | Comparative | Nano- | Fe73.5Si13.5B9Nb3Cu1 | 0.38 | 0.5 | 8 | 355 | 180 | 0.67 |
| | Example | crystal | | | | | | | |
| 69 | Example | Nano- | Fe73.5Si13.5B9Nb3Cu1 | 0.38 | 2.0 | 8 | 355 | 180 | 0.63 |
| | | crystal | | | | | | | |
| 25 | Comparative | Nano- | Fe73.5Si13.5B9Nb3Cu1 | 0.32 | 0.5 | 8 | 300 | 72 | 0.86 |
| | Example | crystal | | | | | | | |
| 17 | Example | Nano- | Fe73.5Si13.5B9Nb3Cu1 | 0.32 | 2.0 | 8 | 300 | 72 | 0.77 |
| | | crystal | | | | | | | |

| | Average | | | | | | | Increase |
|---|---|---|---|---|---|---|---|---|
| | value of | | | | Average of | Volume | | rate of |
| | circu- | | | | circu- | ratio of | | relative under |
| | larities | | | | larities | 160 μm | Relative | permeability |
| Sample | of less | | Gradient | Disper- | of D45 | or more | perme- | C1 and C2 |
| No. | than D50 | C1/C2 | (um −1) | sion | to D55 | (%) | ability | control |
| 56 | 0.60 | 1.03 | 0.00203 | 0.0121 | 0.61 | 5 | 32 | — |
| 57 | 0.64 | 0.95 | 0.00049 | 0.0147 | 0.63 | 5 | 37 | 1.16 |
| 58 | 0.61 | 1.03 | 0.00206 | 0.0126 | 0.62 | 10 | 33 | — |
| 59 | 0.64 | 0.94 | −0.00048 | 0.0149 | 0.61 | 10 | 39 | 1.18 |
| 60 | 0.60 | 1.03 | 0.00205 | 0.0118 | 0.62 | 19 | 35 | — |
| 61 | 0.64 | 0.94 | −0.00042 | 0.0150 | 0.64 | 19 | 42 | 1.20 |
| 62 | 0.60 | 1.03 | 0.00201 | 0.0122 | 0.64 | 30 | 36 | — |
| 63 | 0.65 | 0.95 | −0.00041 | 0.0149 | 0.65 | 30 | 44 | 1.22 |
| 64 | 0.65 | 1.03 | 0.00196 | 0.0125 | 0.66 | 40 | 36 | — |
| 65 | 0.66 | 0.95 | 0.00038 | 0.0148 | 0.65 | 42 | 48 | 1.33 |
| 66 | 0.62 | 1.03 | 0.00208 | 0.0123 | 0.63 | 62 | 38 | — |
| 67 | 0.67 | 0.93 | −0.00039 | 0.0146 | 0.66 | 62 | 50 | 1.32 |
| 68 | 0.64 | 1.05 | 0.00206 | 0.0122 | 0.66 | 78 | 42 | — |
| 69 | 0.66 | 0.95 | 0.00040 | 0.0150 | 0.65 | 83 | 52 | 1.24 |
| 25 | 0.81 | 1.06 | 0.00199 | 0.0121 | 0.82 | 81 | 38 | — |
| 17 | 0.81 | 0.95 | −0.00041 | 0.0149 | 0.77 | 78 | 54 | 1.42 |

Evaluation

As shown in Table 5, it was confirmed that the soft magnetic powders of Examples satisfying C1<C2 (C1/C2 is 0.95 or less) exhibited a high permeability (1.1 times or more) than the soft magnetic powders of Comparative Examples (C1/C2 is 1.03 or more) while having the same composition.

As shown in Table 5, when the gradient of the distribution, the dispersion G2 (mean square error), and the third average circularity C3 of the particle group having a particle size of D45 or more and less than D55 are almost the same, it was confirmed that the relative permeability is increased when particles having a particle size of 160 μm or more are included. It could be confirmed that as the number of particles having a particle size of 160 μm or more increases, a higher relative permeability tends to be exhibited. That is, when the particles having a particle size of 160 μm or more are included in an amount of preferably 19 mass % (volume %) or more, more preferably 30 mass % or more, and still more preferably 60 mass % (volume %) or more, the relative permeability is improved. The upper limit of the particles having a particle size of 160 μm or more is determined from the viewpoint of the filling property and the like, and is preferably 90 mass % (volume %) or less.

### Experimental Example 6

The soft magnetic powder was prepared in the same manner as in Experimental Example 3 except that the thickness at the time of preparing a ribbon by a single-roller melt-spinning method was adjusted by a rotation speed of the roll as shown in Table 6. Thereafter, C1 and C2 were obtained in the same manner as in Experimental Example 3, and in addition, an average particle size D of the soft magnetic particles and an average thickness t of the soft magnetic particles were measured. In addition, a toroidal core was prepared in the same manner as in Experimental Example 1, and the relative permeability was measured. The results are shown in Table 6. In addition, it has been confirmed that the average particle size D of the soft magnetic particles and D50 have a correspondence relationship.

TABLE 6

| | | | | Thickness | Roll mill | | Ball mill |
|---|---|---|---|---|---|---|---|
| | Example/ | | | of metal | | Conveying | Pulverizing |
| Sample | Comparative | Material | | ribbon | Gap | speed | time |
| No. | Example | system | Composition | (μm) | (mm) | (cm/s) | (h) |
| 70 | Example | Nanocrystal | Fe73.5Si13.5B9Nb3Cu1 | 13.0 | 0.32 | 2.0 | 8 |
| 17 | Example | Nanocrystal | Fe73.5Si13.5B9Nb3Cu1 | 20.1 | 0.32 | 2.0 | 8 |
| 71 | Example | Nanocrystal | Fe73.5Si13.5B9Nb3Cu1 | 30.4 | 0.32 | 2.0 | 8 |
| 72 | Example | Nanocrystal | Fe73.5Si13.5B9Nb3Cu1 | 49.7 | 0.32 | 2.0 | 8 |
| 73 | Example | Nanocrystal | Fe73.5Si13.5B9Nb3Cu1 | 102.5 | 0.32 | 2.0 | 8 |
| 74 | Example | Nanocrystal | Fe73.5Si13.5B9Nb3Cu1 | 13.0 | 0.38 | 2.0 | 72 |
| 57 | Example | Nanocrystal | Fe73.5Si13.5B9Nb3Cu1 | 20.1 | 0.38 | 2.0 | 72 |
| 75 | Example | Nanocrystal | Fe73.5Si13.5B9Nb3Cu1 | 30.4 | 0.38 | 2.0 | 72 |
| 76 | Example | Nanocrystal | Fe73.5Si13.5B9Nb3Cu1 | 49.7 | 0.38 | 2.0 | 72 |
| 77 | Example | Nanocrystal | Fe73.5Si13.5B9Nb3Cu1 | 102.5 | 0.38 | 2.0 | 72 |
| 78 | Comparative | Nanocrystal | Fe73.5Si13.5B9Nb3Cu1 | 13.0 | 0.32 | 0.5 | 8 |
| | Example | | | | | | |
| 25 | Comparative | Nanocrystal | Fe73.5Si13.5B9Nb3Cu1 | 20.1 | 0.32 | 0.5 | 8 |
| | Example | | | | | | |
| 79 | Comparative | Nanocrystal | Fe73.5Si13.5B9Nb3Cu1 | 30.4 | 0.32 | 0.5 | 8 |
| | Example | | | | | | |
| 80 | Comparative | Nanocrystal | Fe73.5Si13.5B9Nb3Cu1 | 49.7 | 0.32 | 0.5 | 8 |
| | Example | | | | | | |
| 81 | Comparative | Nanocrystal | Fe73.5Si13.5B9Nb3Cu1 | 102.5 | 0.32 | 0.5 | 8 |
| | Example | | | | | | |
| 82 | Comparative | Nanocrystal | Fe73.5Si13.5B9Nb3Cu1 | 13.0 | 0.38 | 0.5 | 72 |
| | Example | | | | | | |
| 56 | Comparative | Nanocrystal | Fe73.5Si13.5B9Nb3Cu1 | 20.1 | 0.38 | 0.5 | 72 |
| | Example | | | | | | |
| 83 | Comparative | Nanocrystal | Fe73.5Si13.5B9Nb3Cu1 | 30.4 | 0.38 | 0.5 | 72 |
| | Example | | | | | | |
| 84 | Comparative | Nanocrystal | Fe73.5Si13.5B9Nb3Cu1 | 49.7 | 0.38 | 0.5 | 72 |
| | Example | | | | | | |
| 85 | Comparative | Nanocrystal | Fe73.5Si13.5B9Nb3Cu1 | 102.5 | 0.38 | 0.5 | 72 |
| | Example | | | | | | |

| | | | Average | Average | | | | | |
|---|---|---|---|---|---|---|---|---|---|
| | Classification | | value of | value of | | | | | |
| | Mesh | Mesh | circularities | circularities | | | | | Relative |
| Sample | pass | on | of D50 | of less | | D | t | | perme- |
| No. | (um) | (um) | or more | than D50 | C1/C2 | (um) | (um) | t/D | ability |
| 70 | 300 | 72 | 0.77 | 0.80 | 0.96 | 210 | 10 | 0.05 | 55 |
| 17 | 300 | 72 | 0.77 | 0.81 | 0.95 | 213 | 20 | 0.09 | 54 |
| 71 | 300 | 72 | 0.77 | 0.82 | 0.94 | 222 | 31 | 0.14 | 55 |
| 72 | 300 | 72 | 0.78 | 0.81 | 0.96 | 210 | 51 | 0.24 | 53 |
| 73 | 300 | 72 | 0.77 | 0.81 | 0.95 | 210 | 102 | 0.49 | 52 |
| 74 | 180 | 38 | 0.61 | 0.64 | 0.95 | 53 | 10 | 0.19 | 42 |
| 57 | 180 | 38 | 0.60 | 0.64 | 0.94 | 56 | 20 | 0.36 | 41 |
| 75 | 180 | 38 | 0.61 | 0.64 | 0.95 | 54 | 31 | 0.57 | 40 |
| 76 | 180 | 38 | 0.61 | 0.64 | 0.95 | 52 | 53 | 1.02 | 36 |
| 77 | 180 | 38 | 0.60 | 0.64 | 0.94 | 50 | 101 | 2.02 | 34 |
| 78 | 300 | 72 | 0.85 | 0.82 | 1.04 | 210 | 10 | 0.05 | 37 |
| 25 | 300 | 72 | 0.86 | 0.81 | 1.06 | 222 | 20 | 0.09 | 38 |
| 79 | 300 | 72 | 0.84 | 0.82 | 1.02 | 221 | 31 | 0.14 | 38 |
| 80 | 300 | 72 | 0.85 | 0.83 | 1.02 | 210 | 51 | 0.24 | 36 |
| 81 | 300 | 72 | 0.83 | 0.82 | 1.01 | 213 | 102 | 0.48 | 36 |
| 82 | 180 | 38 | 0.61 | 0.60 | 1.02 | 53 | 10 | 0.19 | 35 |
| 56 | 180 | 38 | 0.62 | 0.60 | 1.03 | 54 | 20 | 0.37 | 35 |
| 83 | 180 | 38 | 0.62 | 0.61 | 1.02 | 54 | 31 | 0.57 | 34 |
| 84 | 180 | 38 | 0.63 | 0.61 | 1.03 | 56 | 51 | 0.91 | 30 |
| 85 | 180 | 38 | 0.63 | 0.62 | 1.02 | 54 | 101 | 1.87 | 29 |

Evaluation

As shown in Table 6, it was confirmed that the soft magnetic powders of Examples satisfying C1<C2 (in addition, C1/C2 is 0.95 or less) exhibited a high permeability (1.1 times or more) than the soft magnetic powders of Comparative Examples (C1>C2 and C1/C2 is 1.03 or more) while having the same composition.

In addition, as shown in Table 6, it has been confirmed that when the gradient of the distribution and the average particle size of the soft magnetic particles are almost the same, the relative permeability tends to be high as the average aspect ratio decreases. The average aspect ratio is preferably 1 or less, more preferably 0.5 or less, and still more preferably 0.15 or less in order. A lower limit of the aspect ratio is about 0.05.

### Experimental Example 7

As shown in Table 7, the soft magnetic powder was prepared in the same manner as in Experimental Example 3 except that the composition of the alloy was changed. Thereafter, in the same manner as in Experimental Example 3, C1, C2, and the gradient A and the dispersion σ² (mean square error) in the formula of the approximate straight line were obtained. In addition, a toroidal core was prepared in the same manner as in Experimental Example 1, and the relative permeability was measured. The results are shown in Table 7.

TABLE 7

| | | | | | | Ball |
|---|---|---|---|---|---|---|
| | | | | | | mill |
| | | | | Roll mill | | Pulver- |
| | Example/ | | | | Conveying | izing |
| Sample | Comparative | Material | | Gap | speed | time |
| No. | Example | system | Composition | (mm) | (cm/s) | (h) |
| 25 | Comparative | Nanocrystal | Fe73.5Si13.5B9Nb3Cu1 | 0.32 | 0.5 | 8 |
| | Example | | | | | |
| 17 | Example | Nanocrystal | Fe73.5Si13.5B9Nb3Cu1 | 0.32 | 2.0 | 8 |
| 86 | Comparative | Nanocrystal | Fe81B9Nb7P3 | 0.32 | 0.5 | 8 |
| | Example | | | | | |
| 87 | Example | Nanocrystal | Fe81B9Nb7P3 | 0.32 | 2.0 | 8 |
| 88 | Comparative | Nanocrystal | Fe82.5B7Nb6P3Si1.5Cu0.5 | 0.32 | 0.5 | 8 |
| | Example | | | | | |
| 89 | Example | Nanocrystal | Fe82.5B7Nb6P3Si1.5Cu0.5 | 0.32 | 2.0 | 8 |
| 90 | Comparative | Nanocrystal | Fe84.3P4Si1B10Cu0.7 | 0.32 | 0.5 | 8 |
| | Exam p le | | | | | |
| 91 | Example | Nanocrystal | Fe84.3P4Si1B10Cu0.7 | 0.32 | 2.0 | 8 |
| 92 | Comparative | Nanocrystal | (Fe0.7Co0.3)84B9P3Si3Cr1 | 0.32 | 0.5 | 8 |
| | Example | | | | | |
| 93 | Example | Nanocrystal | (Fe0.7Co0.3)84B9P3Si3Cr1 | 0.32 | 2.0 | 8 |
| 94 | Comparative | Nanocrystal | (Fe0.7Co0.3)79.9B20Cu0.1 | 0.32 | 0.5 | 8 |
| | Example | | | | | |
| 95 | Example | Nanocrystal | (Fe0.7Co0.3)79.9B20Cu0.1 | 0.32 | 2.0 | 8 |
| 96 | Comparative | Nanocrystal | Fe82.5BNb6B8P3Cu0.5 | 0.32 | 0.5 | 8 |
| | Example | | | | | |
| 97 | Example | Nanocrystal | Fe82.5BNb6B8P3Cu0.5 | 0.32 | 2.0 | 8 |
| 98 | Comparative | Nanocrystal | Fe82.5BNb6B7.5P2.5Cu0.5Si1 | 0.32 | 0.5 | 8 |
| | Example | | | | | |
| 99 | Example | Nanocrystal | Fe82.5BNb6B7.5P2.5Cu0.5Si1 | 0.32 | 2.0 | 8 |
| 100 | Comparative | Nanocrystal | (Fe0.90Co0.10)82.5BNb6B7.5P2.5Cu0.5Si1 | 0.32 | 0.5 | 8 |
| | Example | | | | | |
| 101 | Example | Nanocrystal | (Fe0.90Co0.10)82.5BNb6B7.5P2.5Cu0.5Si1 | 0.32 | 2.0 | 8 |
| 102 | Comparative | Nano-heterostructure | Fe73.5Si13.5B9Nb3Cu1 | 0.32 | 0.5 | 8 |
| | Example | | | | | |
| 103 | Example | Nano-heterostructure | Fe73.5Si13.5B9Nb3Cu1 | 0.32 | 2.0 | 8 |
| 104 | Comparative | Nano-heterostructure | Fe80B9Nb7P3 | 0.32 | 0.5 | 8 |
| | Example | | | | | |
| 105 | Example | Nano-heterostructure | Fe80B9Nb7P3 | 0.32 | 2.0 | 8 |
| 106 | Comparative | Nano-heterostructure | (Fe0.7Co0.3)84B9P3Si3Cr1 | 0.32 | 0.5 | 8 |
| | Example | | | | | |
| 107 | Example | Nano-heterostructure | (Fe0.7Co0.3)84B9P3Si3Cr1 | 0.32 | 2.0 | 8 |
| 108 | Comparative | Nano-heterostructure | (Fe0.7Co0.3)79.9B20Cu0.1 | 0.32 | 0.5 | 8 |
| | Example | | | | | |
| 109 | Example | Nano-heterostructure | (Fe0.7Co0.3)79.9B20Cu0.1 | 0.32 | 2.0 | 8 |
| 110 | Comparative | Nano-heterostructure | (Fe0.75Co0.25)86B11P2Si1 | 0.32 | 0.5 | 8 |
| | Example | | | | | |
| 111 | Example | Nano-heterostructure | (Fe0.75Co0.25)86B11P2Si1 | 0.32 | 2.0 | 8 |
| 112 | Comparative | Nano-heterostructure | (Fe0.90Co0.10)86B11P2Si1 | 0.32 | 0.5 | 8 |
| | Example | | | | | |
| 113 | Example | Nano-heterostructure | (Fe0.90Co0.10)86B11P2Si1 | 0.32 | 2.0 | 8 |
| 114 | Comparative | Nano-heterostructure | (Fe0.95Co0.05)86B11P2Si1 | 0.32 | 0.5 | 8 |
| | Example | | | | | |
| 115 | Example | Nano-heterostructure | (Fe0.95Co0.05)86B11P2Si1 | 0.32 | 2.0 | 8 |

| | | | | | | | | | Increase |
|---|---|---|---|---|---|---|---|---|---|
| | | | | | | | | | rate of |
| | | | | Average | | | | | relative |
| | | | Average | value of | | | | | perme- |
| | Classification | | value | circu- | | | | | ability |
| | Mesh | Mesh | of circu- | larities | | | | Relative | under |
| Sample | pass | on | larities | of less | | Gradient | Disper- | perme- | C1 and C2 |
| No. | (um) | (um) | of D50 or | than | C1/C2 | (um −1) | sion | ability | control |
| 25 | 300 | 72 | 0.86 | 0.81 | 1.06 | 0.00199 | 0.0121 | 38 | — |
| 17 | 300 | 72 | 0.77 | 0.81 | 0.95 | −0.00041 | 0.0149 | 54 | 1.42 |
| 86 | 300 | 72 | 0.86 | 0.81 | 1.06 | 0.00209 | 0.0124 | 37 | — |
| 87 | 300 | 72 | 0.78 | 0.80 | 0.98 | −0.00036 | 0.0146 | 51 | 1.38 |
| 88 | 300 | 72 | 0.85 | 0.83 | 1.02 | 0.00201 | 0.0117 | 37 | — |
| 89 | 300 | 72 | 0.76 | 0.82 | 0.93 | −0.00039 | 0.0149 | 50 | 1.35 |
| 90 | 300 | 72 | 0.89 | 0.82 | 1.09 | 0.00201 | 0.0118 | 36 | — |
| 91 | 300 | 72 | 0.78 | 0.85 | 0.92 | −0.00036 | 0.0146 | 52 | 1.44 |
| 92 | 300 | 72 | 0.87 | 0.81 | 1.07 | 0.00208 | 0.0117 | 37 | — |
| 93 | 300 | 72 | 0.80 | 0.82 | 0.98 | −0.00037 | 0.0149 | 53 | 1.43 |
| 94 | 300 | 72 | 0.83 | 0.81 | 1.02 | 0.00209 | 0.0123 | 38 | — |
| 95 | 300 | 72 | 0.79 | 0.82 | 0.96 | −0.00036 | 0.0145 | 51 | 1.34 |
| 96 | 300 | 72 | 0.83 | 0.82 | 1.01 | 0.00216 | 0.0120 | 38 | — |
| 97 | 300 | 72 | 0.78 | 0.82 | 0.95 | −0.00029 | 0.0148 | 51 | 1.34 |
| 98 | 300 | 72 | 0.82 | 0.81 | 1.01 | 0.00215 | 0.0123 | 37 | — |
| 99 | 300 | 72 | 0.78 | 0.82 | 0.95 | −0.00027 | 0.0150 | 50 | 1.35 |
| 100 | 300 | 72 | 0.83 | 0.80 | 1.04 | 0.00217 | 0.0120 | 37 | — |
| 101 | 300 | 72 | 0.79 | 0.81 | 0.98 | −0.00029 | 0.0146 | 49 | 1.32 |
| 102 | 300 | 72 | 0.85 | 0.84 | 1.01 | 0.00205 | 0.0122 | 32 | — |
| 103 | 300 | 72 | 0.77 | 0.85 | 0.91 | −0.00040 | 0.0146 | 48 | 1.50 |
| 104 | 300 | 72 | 0.86 | 0.83 | 1.04 | 0.00206 | 0.0118 | 33 | — |
| 105 | 300 | 72 | 0.79 | 0.82 | 0.96 | −0.00032 | 0.0146 | 47 | 1.42 |
| 106 | 300 | 72 | 0.89 | 0.84 | 1.06 | 0.00200 | 0.0118 | 32 | — |
| 107 | 300 | 72 | 0.80 | 0.84 | 0.95 | −0.00038 | 0.0145 | 48 | 1.50 |
| 108 | 300 | 72 | 0.87 | 0.85 | 1.02 | 0.00205 | 0.0117 | 33 | — |
| 109 | 300 | 72 | 0.78 | 0.83 | 0.94 | −0.00040 | 0.0146 | 46 | 1.39 |
| 110 | 300 | 72 | 0.88 | 0.86 | 1.02 | 0.00209 | 0.0117 | 33 | — |
| 111 | 300 | 72 | 0.78 | 0.84 | 0.93 | −0.00034 | 0.0149 | 45 | 1.36 |
| 112 | 300 | 72 | 0.87 | 0.85 | 1.02 | 0.00212 | 0.0119 | 32 | — |
| 113 | 300 | 72 | 0.79 | 0.83 | 0.95 | −0.00030 | 0.0147 | 43 | 1.34 |
| 114 | 300 | 72 | 0.87 | 0.85 | 1.02 | 0.00208 | 0.0117 | 31 | — |
| 115 | 300 | 72 | 0.78 | 0.83 | 0.94 | −0.00031 | 0.0150 | 42 | 1.35 |

Evaluation

As shown in Table 7, it was confirmed that the results shown in Tables 1 to 6 were obtained also in Examples and Comparative Examples of soft magnetic powders having different compositions.

### Experimental Example 8

In the sample Nos. 116, 118, 120, 122, 124, and 126, an Fe powder, an Fe—Ni powder, an Fe—Co powder, and an Fe—Si powder each having a D50=1 μm were added to the soft magnetic powder of the sample No. 25 of Experimental Example 3, and in the sample Nos. 117, 119, 121, 123, 125, and 127, an Fe powder, an Fe—Ni powder, an Fe—Co powder, and an Fe—Si powder each having a D50=1 μm were added to the soft magnetic powder of the sample No. 17 of Experimental Example 3, and mixed so that the area proportion of the mixed soft magnetic powder in the cross section of the toroidal core was the ratio described in Table 8. The toroidal core was prepared in the same manner as in Experimental Example 3 by using the mixed powder, and the relative permeability was measured. The results are shown in Table 8.

TABLE 8

| | | | | Average | Average | | | | | | |
|---|---|---|---|---|---|---|---|---|---|---|---|
| | | | | value | value | | | | | Area ratio | |
| | | | | C1 of | C2 of | | | | | of mixed | |
| | | | | circu- | circu- | | | | Mixed | powder to | |
| | Example/ | | | larities | larities | | | | powder | magnetic | Relative |
| Sample | Comparative | Material | | of D50 | of less | | Gradient | Disper- | compo- | material | perme- |
| No. | Example | system | Composition | or more | than D50 | C1/C2 | (um −1) | sion | sition | area | ability |
| 25 | Comparative | Nanocrystal | Fe73.5Si13.5B9Nb3Cu1 | 0.86 | 0.81 | 1.06 | 0.00199 | 0.0121 | — | — | 38 |
| | Example | | | | | | | | | | |
| 17 | Example | Nanocrystal | Fe73.5Si13.5B9Nb3Cu1 | 0.77 | 0.81 | 0.95 | −0.00041 | 0.0149 | — | — | 54 |
| 116 | Comparative | Nanocrystal | Fe73.5Si13.5B9Nb3Cu1 | 0.86 | 0.81 | 1.06 | 0.00199 | 0.0121 | Fe | 9.8 | 42 |
| | Example | | | | | | | | | | |
| 117 | Example | Nanocrystal | Fe73.5Si13.5B9Nb3Cu1 | 0.77 | 0.81 | 0.95 | −0.00041 | 0.0149 | Fe | 9.9 | 59 |
| 118 | Comparative | Nanocrystal | Fe73.5Si13.5B9Nb3Cu1 | 0.86 | 0.81 | 1.06 | 0.00199 | 0.0121 | Fe | 19.8 | 44 |
| | Example | | | | | | | | | | |
| 119 | Example | Nanocrystal | Fe73.5Si13.5B9Nb3Cu1 | 0.77 | 0.81 | 0.95 | −0.00041 | 0.0149 | Fe | 19.7 | 63 |
| 120 | Comparative | Nanocrystal | Fe73.5Si13.5B9Nb3Cu1 | 0.86 | 0.81 | 1.06 | 0.00199 | 0.0121 | Fe | 29.8 | 43 |
| | Example | | | | | | | | | | |
| 121 | Example | Nanocrystal | Fe73.5Si13.5B9Nb3Cu1 | 0.77 | 0.81 | 0.95 | −0.00041 | 0.0149 | Fe | 30 | 60 |
| 122 | Comparative | Nanocrystal | Fe73.5Si13.5B9Nb3Cu1 | 0.86 | 0.81 | 1.06 | 0.00199 | 0.0121 | Fe—Ni | 19.2 | 45 |
| | Example | | | | | | | | | | |
| 123 | Example | Nanocrystal | Fe73.5Si13.5B9Nb3Cu1 | 0.77 | 0.81 | 0.95 | −0.00041 | 0.0149 | Fe—Ni | 19.3 | 64 |
| 124 | Comparative | Nanocrystal | Fe73.5Si13.5B9Nb3Cu1 | 0.86 | 0.81 | 1.06 | 0.00199 | 0.0121 | Fe—Co | 19.3 | 42 |
| | Example | | | | | | | | | | |
| 125 | Example | Nanocrystal | Fe73.5Si13.5B9Nb3Cu1 | 0.77 | 0.81 | 0.95 | −0.00041 | 0.0149 | Fe—Co | 19.5 | 61 |
| 126 | Comparative | Nanocrystal | Fe73.5Si13.5B9Nb3Cu1 | 0.86 | 0.81 | 1.06 | 0.00199 | 0.0121 | Fe—Si | 19.6 | 44 |
| | Example | | | | | | | | | | |
| 127 | Example | Nanocrystal | Fe73.5Si13.5B9Nb3Cu1 | 0.77 | 0.81 | 0.95 | −0.00041 | 0.0149 | Fe—Si | 19.7 | 62 |

Evaluation

As shown in Table 8, it was confirmed that the results as shown in Tables 1 to 6 were obtained also in the magnetic cores of Examples and Comparative Examples to which the magnetic powder was added and mixed.

### DESCRIPTION OF REFERENCE NUMERALS

2 Soft magnetic alloy particle
2a, 2b Main surface
2c Side surface
2e Perfect circle
31 Nozzle
32 Molten metal
33 Roll
34 Soft magnetic alloy ribbon
35 Chamber
40 Pulverizing device
42 Pulverizing roller
42a Pulverizing irregular surface
42b Central reference plane for irregularities

What is claimed is:

1. A soft magnetic powder comprising: a first particle group including particles having a particle size of D50 or more; and a second particle group including particles having a particle size of less than D50, wherein
an average value of circularities of the particles belonging to the first particle group is defined as a first average circularity C1,
an average value of circularities of the particles belonging to the second particle group is defined as a second average circularity C2, and
C1<C2 is satisfied.

2. The soft magnetic powder according to claim 1, wherein a gradient of an approximate straight line obtained from a circularity distribution with respect to the particle sizes of the particles belonging to the first particle group and the second particle group is −0.00154 μm or more and −0.00014 μm or less.

3. The soft magnetic powder according to claim 2, wherein a dispersion of the circularity distribution is 0.002 or more and 0.040 or less.

4. The soft magnetic powder according to claim 2, wherein
an average value of circularities of particles belonging to a third particle group including particles having a particle size of D45 or more and less than D55 among the particles belonging to the first particle group and the second particle group is defined as a third average circularity C3, and
the third average circularity C3 is 0.6 or more and 0.92 or less.

5. The soft magnetic powder according to claim 1, wherein the particles belonging to the first particle group and the second particle group each have a main surface and a thickness perpendicular to the main surface.

6. The soft magnetic powder according to claim 5, wherein an average aspect ratio indicating a ratio of the particle thickness with respect to an equivalent circular diameter obtained from an area of the main surface is 1 or less.

7. A magnetic core comprising the soft magnetic powder according to claim 1.

8. A magnetic component comprising the soft magnetic powder according to claim 1.

9. An electronic device comprising the soft magnetic powder according to claim 1.
